(19) United States
(12) Patent Application Publication
(10) Pub. No.: US 2014/0343976 A1
(43) Pub. Date: Nov. 20, 2014

(54) Computer-implemented systems and methods for restaurant reservations and food orders

(71) Applicants: Nitesh Ahluwalia, Brampton (CA); Alex Sayavong, Concord (CA)

(72) Inventors: Nitesh Ahluwalia, Brampton (CA); Alex Sayavong, Concord (CA)

(21) Appl. No.: 14/272,211

(22) Filed: May 7, 2014

Related U.S. Application Data
(60) Provisional application No. 61/820,494, filed on May 7, 2013.

(51) Int. Cl. G06Q 10/02; G06Q 50/12

(52) U.S. Cl. CPC G06Q 10/02; G06Q 50/12
USPC 705/5

(57) ABSTRACT

A system and method are provided which allow customers making restaurant reservations to, in addition to the other information required to make a booking, also specify the time they wish their meal, or the various courses therein, to arrive at their table. This information is relayed to the restaurant so that the meal is ready at the desired time. In addition, a system and method are provided which allow customers to make reservations at restaurants which are accessible by other reservation guests through the use of a unique identification code.

### CROSS-REFERENCE TO RELATED APPLICATIONS

This is a utility patent application being filed in the United States as a non-provisional application for patent under Title 35 U.S.C. §100 et seq. and 37 C.F.R. §1.53(b) and, claiming the benefit of the prior filing date under Title 35, U.S.C. §119(e) of the United States provisional application for patent that was filed on May 7, 2013 and assigned Ser. No. 61/820,494, which application is incorporated herein by reference in its entirety.

### FIELD OF THE INVENTION

The present invention relates to the field of restaurant reservation systems. More particularly, the present invention relates to a computer-implemented system and method for on-line restaurant reservations and food orders.

### BACKGROUND OF THE INVENTION

Since the introduction of the Internet, its growth has been phenomenal. Businesses can use the connectivity provided by the Internet to interact with their customers in ways that were difficult, or impossible, before its creation and wide-spread adoption. One excellent example of the ways in which commercial enterprises may interact with their customers online is in the restaurant industry.

Before the advent of the Internet, prospective restaurant customers might make reservations at the restaurant by telephone. Customers doing this would have to call the restaurant manually, wait for an employee of the restaurant to answer the phone, make a reservation by verbally advising the employee of the restaurant of the desired reservation time, number of guests, and name of person making the reservation; and then receive a verbal response as to whether the desired time and number of parties fit available seating options at the restaurant. Because this process is performed manually, there is always the potential for mistakes to be made.

After receiving a reservation for a particular time, many restaurants would find it advantageous to confirm a reservation, thereby attempting to ensure that the parties reserving a time and table would indeed show up at that time for the reservation. This would avoid the disadvantages of missed reservations, which include empty tables because tables cannot always be filled by the restaurant with substitute diners on short notice, and such missed reservations result in lost revenue for the restaurant. Of course, confirming reservations in this way again occupies the time and effort of an employee of the restaurant, who has to phone the customers, often the same day as the reservation itself, and remind the customers of the reservation later that day.

These manual processes take time and energy away from other aspects of the restaurant's business, and costs the restaurant in lost productivity and excess employee wages. It is also very difficult for either the customer or the restaurant to change a booking once it has been made, as this requires one of the two parties to contact the other, verbally discuss changing the reservation, and the restaurant employee to make those changes to the reservation (again raising the possibility that mistakes are made).

With the advent of the Internet, and networked computing systems in general, and their ability to facilitate two-way communication between a customer and a restaurant, many restaurants found it advantageous to move to a network-based (e.g. Internet-based) reservation booking system. This allowed the customer to make a reservation booking with a restaurant from the convenience of, for example, his or her own computer or Internet-enabled mobile device. This also allows the reservation, including available time slot, to be negotiated as between the customer and the receiving computer system immediately, as opposed to through verbal negotiation between the customer and an employee of the restaurant.

However, while the Internet allows for many advantages, existing systems and methods for negotiating restaurant reservation bookings typically only take the name of the party making the reservation (for identification purposes), the number of people in the reserving party, and a time when the party will attend at the restaurant. No further information is typically exchanged during the making of the reservation by the customer and the restaurant itself.

While the customer may arrive at the particular time for the reservation, the restaurant will take the customer's food order at some unknown time after the customer arrives at the restaurant. The restaurant will then prepare the meal, which will be fully prepared at some additional unknown time after the taking of the order. Overall, in known methods and systems, there are therefore no guarantees as to when, after the reservation arrival time, the restaurant will serve the customer's food. This can be a big disadvantage for those customers who, for example, are in a hurry or who have limited time within which to eat. This can result in those customers not eating at particular restaurants that the customer feels will take too long to prepare and/or serve their meals.

Furthermore, while booking a particular reservation time and confirming this time back to the customer helps to encourage the customer to show up at the restaurant at that particular time, this does not ameliorate the situation where customers show up at the correct time, but remain at the table beyond their expected time period, either due to delays in serving those customers the various courses of their meal, or due to the customers taking excess time to eat.

Furthermore, existing systems and known methods for taking reservations, being manual, do not typically allow for the taking of the food orders of each individual reservation group member, which can be a disadvantage in the same way that not taking the specific time of the reservation can be as mentioned earlier, in that the group only has a minimal amount of time within which to attend, eat, and leave the restaurant and return to work, for example.

There is therefore a need for a system and method for placing restaurant reservations which ameliorates at least some of the deficiencies in existing systems, namely whereby customers who desire to eat at particular times, or who have a distinct lack of time in their schedules but still wish to eat out, may be allowed to do so by the present invention, including in situations where they may wish to order multiple courses. There is also a need for restaurant reservation and ordering systems that properly accommodate, and allow, third parties who plan to attend at the restaurant along with the customer who booked the reservation, to conveniently place their own specific food orders within the context of a single online restaurant reservation booking.

### SUMMARY OF THE INVENTION

The present invention provides a system and method for an online restaurant reservation booking system that ameliorates deficiencies in the known methods for restaurant reservations.

It is a further object of this invention to provide a system and method which allows customers who are making restaurant reservations, in addition to the other information required to make a restaurant reservation booking, to also specify the time they wish their meal, or various courses therein, to arrive at their table. This information is then relayed to the restaurant in question along with the other reservation information (i.e. the name, number of guests, and time of the reservation) and the restaurant can use the information to prepare the meal ahead of the customer's desired service time, so that the meal is ready at the desired time.

The present invention also provides a system and method which allows reservations, both for eat-in and take-out/delivery, to be made by one customer, but provides that customer with a unique identification code which allows the reservation to be uniquely identified amongst all reservations placed through the system of the invention, and which can be given to third parties in order to allow them to access the particular reservation in the present system. This system and method allows those third parties to add information to that reservation without requiring intervention of the original customer, for example for the third parties to, for example, select meal orders, courses, specify desired delivery times or preparation times of the various meals and courses, food restrictions or requirements, contact information, reservation preferences, or any other information. This also allows a single reservation to be created containing specific information about a number of third parties, which in turn allows for centralized payment in that the original customer, for example, may pay for the entire reservation, including the food orders selected by all of the other third parties.

One aspect of the present invention provides a computer-implemented online restaurant reservation booking system for use by a customer to make a restaurant reservation booking at a restaurant, which also allows one or more other individuals, being reservation guests, to modify said restaurant reservation booking, the computer-implemented booking system of the invention comprising a web application for receiving from the customer the restaurant reservation booking, the web application assigning the restaurant reservation booking a unique identification code, which is usable by the one or more reservation guests to access the restaurant reservation booking via the web application in order to modify the restaurant reservation booking. The booking can be modified by, for example, adding, removing, or substituting one or more menu items in the restaurant reservation booking, and/or changing a delivery time of the one or more menu items. The web application further provides the restaurant, via a communications means, with information concerning the restaurant reservation booking.

A further aspect of the present invention provides a computer-implemented online restaurant reservation booking system allowing the customer the choice of one or more menu items, restaurant reservation time, time of delivery of at least one of the one or more menu items, and the names of one or more reservation guests.

A further aspect of the present invention provides a computer-implemented online restaurant reservation booking system allowing the customer to, while making the booking, also select one or more menu items for the reservation.

A further aspect of the present invention provides a computer-implemented online restaurant reservation booking system wherein the unique identification code comprises information about the customer that uniquely identifies the customer.

A further aspect of the present invention provides that the unique identification code comprises a unique string of random characters.

A further aspect of the present invention provides that the unique identification code comprises text selected by the customer.

A further aspect of the present invention provides that the communications means by which the unique identification code is sent to the customer or to the one or more reservation guests is e-mail.

A further aspect of the present invention provides that the communications means by which the unique identification code is sent to the customer or to the one or more reservation guests is fax transmission.

A further aspect of the present invention provides that the communications means by which the unique identification code is sent to the customer or to the one or more reservation guests is via printer, whether standalone printer printing a hard copy of the information, through wireless printer access, or where the printer is hooked through web access printer services to print through the Internet.

A further aspect of the present invention provides that the communications means by which the unique identification code is sent to the customer or to the one or more reservation guests is by automated telephone call.

A further aspect of the present invention provides that the communications means by which the unique identification code is sent to the customer or to the one or more reservation guests is by display on a website.

A further aspect of the present invention provides that the communications means by which the unique identification code is sent to the customer or to the one or more reservation guests is by electronic message sent to a mobile device, which can include a mobile telephone, a tablet set up for mobile access, or a PDA, or any other mobile device that has data transmission capability.

A further aspect of the present invention provides that the online restaurant reservation booking system allows the customer to make electronic payment for the entire restaurant reservation booking Electronic payment can be made by credit card, electronic debit card transaction, electronic wallet debiting an electronic account holding funds, decentralized currency, or any other suitable electronic payment processing means.

A further aspect of the present invention provides that the web application notifies the customer when one or more of the reservation guests have accessed the restaurant reservation booking and selected the one or more menu items. Further aspects of the present invention provide that the web application can notify the customer of this fact by e-mail, fax transmission, via display on a website, electronic message to a mobile device including mobile telephone, mobile tablet, PDA, and the like. The notification can be given when the first reservation guest accesses the system, the last guest does so, or any number in between, as may be desired.

A further aspect of the present invention provides that the restaurant reservation booking also includes one or more desired times for the one or more menu items selected by the customer and by the one or more reservation guests to be served.

A further aspect of the present invention provides that the restaurant reservation booking also includes a desired time by which the customer and the one or more reservation guests are to be finished at the restaurant.

A further aspect of the present invention provides that one or more restaurants may access the web application and add, delete, and update the menu items made available by each of those restaurants.

A further aspect of the present invention provides that the one or more restaurants may access the web application and add, delete, and update the price of the menu items made available by each of the one or more restaurants.

A further embodiment of the present invention provides a method for providing an improved restaurant reservation booking through an online restaurant reservation booking system, comprising:
providing an online booking system for a customer to make a restaurant reservation booking,
enabling the customer to select one or more menu items offered by the restaurant, the one or more menu items being included in the restaurant reservation booking,
assigning the restaurant reservation booking a unique identification code,
providing at least the customer and optionally the at least one or more reservation guests with the unique identification code,
said unique identification code allowing the one or more reservation guests to access the restaurant reservation booking via the web application in order to modify the restaurant reservation booking by;
   (a) adding, removing, or substituting one or more menu items in the restaurant reservation booking, and/or
   (b) changing a delivery time of the one or more menu items.

A further aspect of the present invention provides a method further comprising the steps of:
notifying the customer once all of the one or more reservation guests have accessed the restaurant reservation booking;

A further aspect of the present invention provides a method further comprising the steps of:
prompting the customer to access the computer reservation booking system, and
collecting payment from the customer for at least a portion of the restaurant reservation booking cost.

A further aspect of the present invention provides a method further comprising providing the customer the option to make full payment of the restaurant reservation booking.

A further aspect of the present invention provides a method further comprising collecting payment from the one or more reservation guests for at least a portion of the restaurant reservation booking cost.

A further aspect of the present invention provides a method further comprising collecting from the customer electronic contact information for the one or more reservation guests and sending the unique identification code directly to the one or more reservation guests via electronic means. Further aspects of the present invention provide that the web application can notify the customer of this fact by e-mail, fax transmission, via display on a website, electronic message to a mobile device including mobile telephone, mobile tablet, PDA, and the like. The notification can be given when the first reservation guest accesses the system, the last guest does so, or any number in between, as may be desired.

These and other objects and features of this invention will become more readily apparent upon reference to the following detailed description of a preferred embodiment as illustrated in the accompanying drawings.

### BRIEF DESCRIPTION OF THE DRAWINGS

The accompanying drawings illustrate embodiments of the invention and, together with the description, serve to explain the principles of the invention.

FIG. 1 is a block diagram of an embodiment of the present invention, illustrating the high-level operation of the system and method of the embodiment of the invention, its components, and its interaction with the persons using the system and method.

FIG. 2 is an example of a display screen of an online restaurant system of the present invention in which the user, a customer, may search restaurants by various criteria and make reservations at a particular restaurant.

FIG. 3 is an example of a display screen of an online restaurant system of the present invention in which the customer has confirmed their reservation and is being prompted to confirm selections relating to the meal.

FIG. 4 is an example of a display screen of an online restaurant system of the present invention in which a customer is selecting menu items he or she wishes to purchase from the restaurant as a pre-order for his or her reservation meal.

FIG. 5 is an example of a display screen of an online restaurant system of the present invention in which a restaurant profile may be created and menu items added to that restaurant's menu in the online restaurant system database.

FIG. 6 is an example of a display screen of an online restaurant system of the present invention in which menu items may be added to a restaurant's menu database.

FIG. 7 is an example of a display screen of an online restaurant system of the present invention in which a restaurant operator may view the reservations made at their restaurant through the system of the present invention.

FIG. 8 is an example of a display screen of an online restaurant system of the present invention in which a restaurant operator may view the menu items that a customer has pre-ordered for his or her reservation at their restaurant.

FIG. 9 is an example of a display screen of an online restaurant system of the present invention in which a restaurant operator may view the reservations made by one or more customers at that restaurant in a calendar view over the upcoming month.

FIG. 10 is an example of a home display screen of an online restaurant system of the present invention.

FIG. 11 is an example of a display screen of an online restaurant system of the present invention in which the user, a customer, may search restaurants by various criteria.

FIG. 12 is an example of a display screen of an online restaurant system of the present invention showing a restaurant profile and menu selections.

FIG. 13 is an example of a display screen of an online restaurant system of the present invention in which a customer may make a reservation at a restaurant.

FIG. 14 is an example of a display screen of an online restaurant system of the present invention in which a customer is selecting menu items he or she wishes to purchase from the restaurant as a pre-order for his or her reservation meal.

FIG. 15 is an example of a display screen of an online restaurant system of the present invention in which a customer may confirm a restaurant reservation.

FIG. 16 is an example of a display screen of an online restaurant system of the present invention in which a reservation is being accessed that has already been submitted and had menu items selected at an earlier time.

FIG. 17 is an example of a display screen of an online restaurant system of the present invention in which a restaurant profile may be created.

FIG. 18 is an example of a display screen of an online restaurant system of the present invention in which menu items may be added to a restaurant's menu database.

FIG. 19 is an example of a display screen of an online restaurant system of the present invention in which a restaurant may view booked reservations.

FIG. 20 is an example of a display screen of an online restaurant system of the present invention in which a particular reservation's details are being viewed.

FIG. 21 is an example of a display screen of an online restaurant system of the present invention in which a restaurant may select how that restaurant wishes to receive notifications.

FIG. 22 is an overall schema diagram showing the interrelated tables of the database of an embodiment of the present invention, showing the fields in each table, the field types, and the linkages (or lack thereof) between the various tables.

### DETAILED DESCRIPTION OF THE INVENTION

A detailed description of various illustrative embodiments and possible implementations of the present invention will now be provided. It should be appreciated that the present invention provides many applicable inventive concepts that can be embodied in a wide variety of specific contexts, and that the embodiments described are purely exemplary and do not limit the scope of the present invention. The invention extends to alternatives, modifications, and equivalents to each of its elements, all of which are included in the scope of the invention.

The present invention provides a system and a method for an online restaurant reservation booking system that ameliorates deficiencies in the known systems and methods of making restaurant reservations.

This invention provides a system and method which allows customers who are making restaurant dine-in reservations, in addition to the other information required to make a restaurant reservation booking, to also specify the time they wish their meal, or various courses comprising the meal, to arrive at their table. This information is then relayed to the restaurant in question, along with the other reservation information (i.e. the name, number of guests, and time of the reservation), and the restaurant can use the information to prepare the meal ahead of the customer's desired service time so that the meal is ready at the desired time.

The present invention also provides a system and a method which allows reservations to be made by one customer, but provides that customer with a reservation booking code which allows the reservation to be uniquely identified amongst all reservations placed through the system of the invention, and which can be given to third parties in order to allow them to access the particular reservation in the present system. This system and method allows those third parties to add information to that reservation without requiring intervention of the original customer, for example for the third parties to, for example, select meal orders, courses, specify desired delivery times or preparation times of the various meals and courses, food restrictions or requirements, contact information, reservation preferences, or any other information. This also allows a single reservation to be created containing specific information about a number of third parties, which in turn allows for centralized payment in that the original customer, for example, may pay for the entire reservation, including the food orders selected by all of the other third parties.

As will be seen from the following description, the present invention involves a system comprised of many interdependent software components, database structures, automation scripts or computer programs, hardware components, and control interfaces. Examples of well-known computer systems that may be suitable for use in the present system with aspects of the subject matter described herein include, but are not limited to, personal computers, server computers, laptop devices, multiprocessor systems, network personal computers, mainframe computers, distributed computing environments where tasks are performed by remote processing linked through a communications network, remote systems, etc., and the like. In a distributed computing environment, program components or modules may be located in both local and remote computer storage media including memory storage devices. Remote systems may involve remote computers, such as personal computers, a router, a server, a network personal computer, a peer device or other common network node, and the like.

In addition, components of suitable platforms may include, but are not limited to, a central processing unit, a system memory, and a system bus that integrates various system components, including the system memory to the processing unit. The system memory may include computer storage media in the form of volatile or non-volatile memory, such as read only memory (ROM), random access memory (RAM), EEPROM, flash memory, CD-ROM, DVD, magnetic storage devices, etc., which can be used to store the desired information and is accessible by the computer system. The system bus may be any of several types of bus structures including a memory controller, a peripheral bus, and a local bus of various bus architectures. Suitable platforms also include a variety of computer-readable media comprising, for example, computer communication media and computer storage media. Computer storage media may include both removable and non-removable media, or volatile and non-volatile media alike, for information storage of computer-readable instructions, program modules, data structures, or other data, etc. Computer communication media generally comprises any information delivery media for delivering media information to a user, computer-readable instructions, program modules, data structures, or other data, etc.

### Exemplary Embodiments

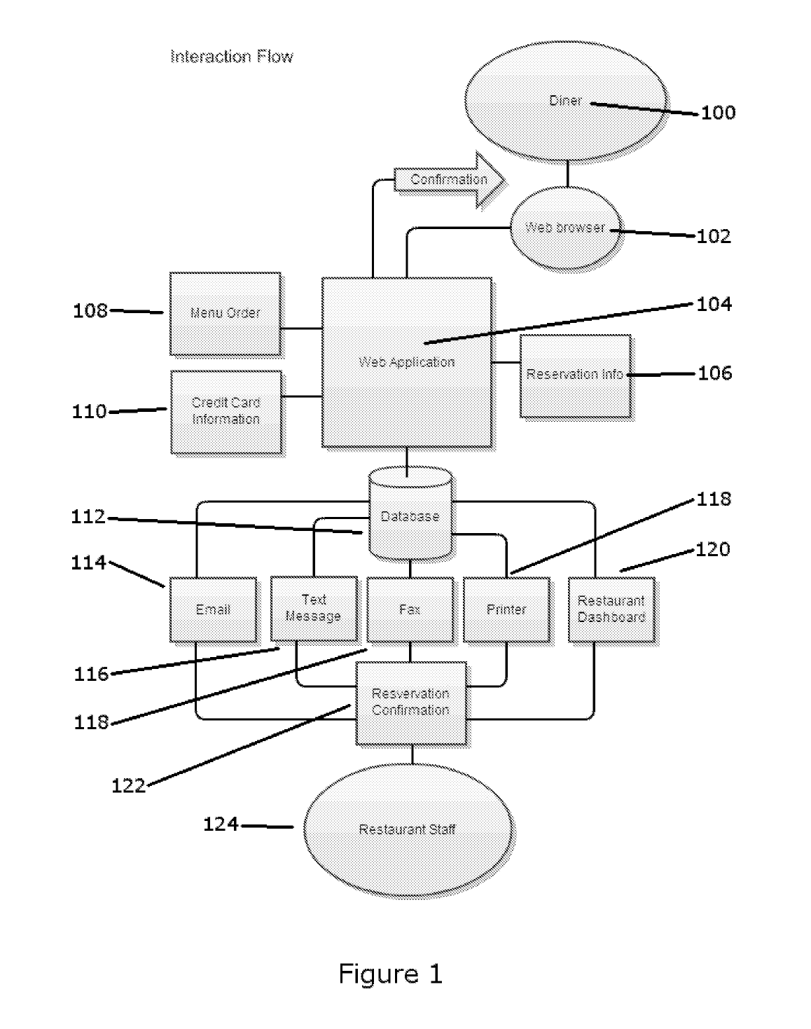

In this respect, FIG. 1 shows a block diagram of an embodiment of the present invention, illustrating the high-level operation of the computer-implemented system and method of the present invention, along with components, and its interaction with customers. In the embodiment shown in FIG. 1, a customer 100, referred to as diner in the figure, uses a web browser 102 that interacts through a network, preferably a public network such as the Internet, with a web application 104, which can be for example hosted on a server.

The term “web application” as used herein is meant to refer to any application existing on a network or reachable via network protocol transmissions, which can receive and transmit instructions and data over that network, and the term is not limited to those applications existing on the Internet, being simply one embodiment of a network. The web browser and web application may operate on servers or workstations which run on any type of operating system, such as Windows operating systems, Unix and Linux, Apple OS, Android, and it is further understood that the web browser and web application are not required to run on the same operating system. The servers and workstations of the present invention, and particularly the server which is used to execute the computer software implemented present invention, typically include a central processing unit (CPU) (or processor), memory, mass storage, I/O device such as disk drive or optical disc, computer display such as a flat panel or CRT display, input devices including keyboard, mouse, touch screen displays or gesture recognition, all of which components are connected directly or indirectly via a system bus. In operation, the computer product of the present invention is loaded on the mass storage of the server as conventionally known. During execution, the software product of the present invention is loaded from mass storage into memory, and the software executed by the processor. The software displays the output of its processing via the display, and receives outside input via the input devices such as keyboard and mouse. Where the web browser and web application are on remotely located computer systems, the customer will interact in the manner just described with the local web browser running on a local computer, which web browser will send the interactions and information provided by the customer to the web application on the remote server via the network to which both computer systems are connected. Output from the web application is, likewise, sent back to the web browser in a similar manner. Accordingly, a remote computer can communicate with the web application of the present invention, and vice versa.

The web application 104 can receive reservation information 106 relating to one or more restaurants, menu orders 108, and credit card information 110, all of which is input by the customer 100 through the web browser 102 through any suitable input means including traditional keyboards, pointing devices, touchscreens, voice activation, and gesture-based commands. The information that the customer 100 has input into the web application 104 is stored in a database 112 to the web application. The database software may be of any type, including MySQL, SQLite3, PostgreSQL, MongoDB, and the like, and the particular database to be used may be selected as required to select for its performance, reliability, and cost characteristics. Especially preferred is MySQL.

The term “web browser” as used herein, similar to “web application”, may refer to any computer program designed to allow a user, such as the customer, to interact with a remote server and send and receive instructions and data from any such server.

It should be noted that the elements in FIG. 1 are illustrated as being directly connected for illustrative purposes only. In execution, all that is required is that the various elements, for example web browser 102 and web application 104 are communicatively coupled to the same network/sub-network such that communications between the elements may occur. The network may include, for example, a local-area network (LAN) and/or a wide-area network (WAN), and may include wired and/or wireless links, the Public-Switched Telephone Network (PSTN), wireless communications network, Bluetooth communications, or the like. The communications occurring over such networks will typically be made via standard communications protocols, most typically TCP/IP, but may be any other suitable communications protocol including UDP, ICMP, Bluetooth, OSI, SMTP, HTTP, FTP, SSL, and/or TLS.

Once the customer 100 has input all the information required by the system of the present invention to create a restaurant reservation, that information (comprising the reservation information 106, menu order 108, and, if submitted by the customer 100, credit card information 110), are stored in the database 112. This information, as stored, can then be transmitted by the web application 104 by any communications means including email 114, text message to a mobile device 116, fax 118, printer 120, or a restaurant dashboard 122, which in one embodiment may be a specific web page generated by web application 104. It is to be understood that any communications means which allows the reservation information (106, 108 and 110) to be transmitted to the restaurant to which the reservation information relates can be used in the present invention to same effect as those means disclosed herein. All of these communications means allow the reservation confirmation 124, containing some or all of the information previously entered into the system by the customer 100, to be viewed by the restaurant staff 126 at any convenient location, including particularly at the restaurant itself.

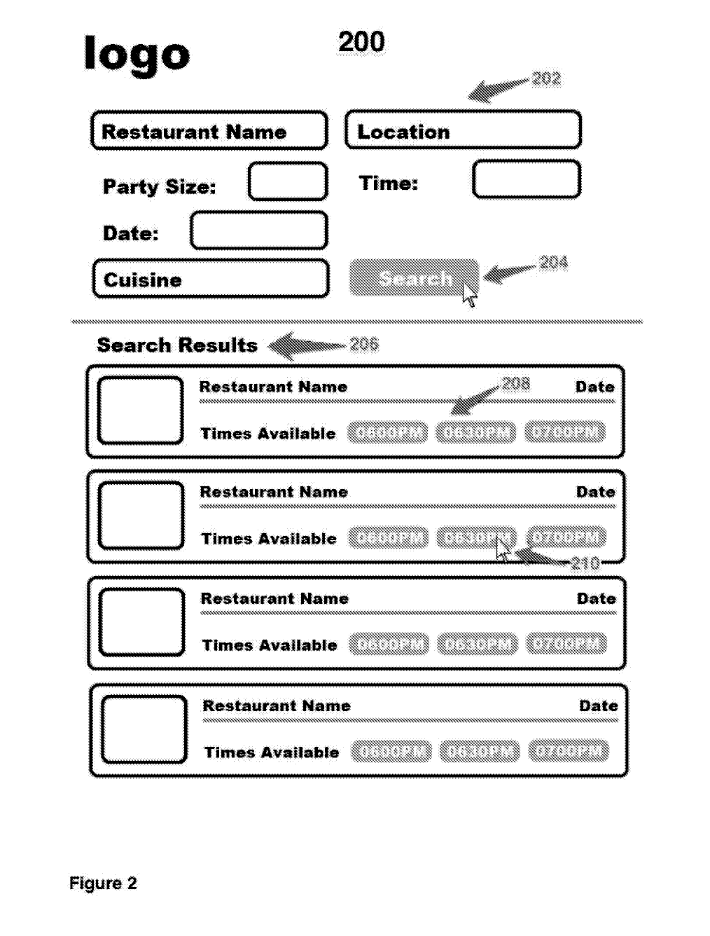

FIG. 2 illustrates a display screen 200 of an embodiment of an online restaurant system of the present invention in which the customer may search restaurants by various criteria and make reservations at a particular restaurant. The display screen 200 may be any form of display to the customer, including but not limited to display via computer terminal, touchscreen terminal, mobile device, website, computerized television, or any other means known to the person skilled in the art. The search area 202 allows the customer to search for suitable restaurants by various criteria. In the example of FIG. 2 this includes restaurant name, location, party size, time, date, and cuisine desired. A search button 204 submits the search to the online restaurant system, which queries a database 112 containing information about various restaurants that have been entered in the system of the present invention. The online restaurant system returns a list of suitable restaurants 206 meeting the criteria submitted by the customer, as well as a series of reservation times 208, previously entered in the database, which are noted by the system to be still available for the customer to select. The customer may then select one such reservation slot, as shown at 210.

As previously described, the information stored in the online restaurant system of the present invention is preferably stored in a database 112, and such information preferably includes:
restaurant information;
reservation information such as that disclosed above, including location, party size, time date of reservation, and a unique identifier code for each reservation to uniquely identify it from all others; and,
meal information corresponding to foods offered by the various restaurants.

This information can be stored in the database in any known manner and stored in known ways and using known programmatic techniques. As well, the actual table and database structure to hold this information may be dealt with in any number of ways, with any number of interrelated tables.

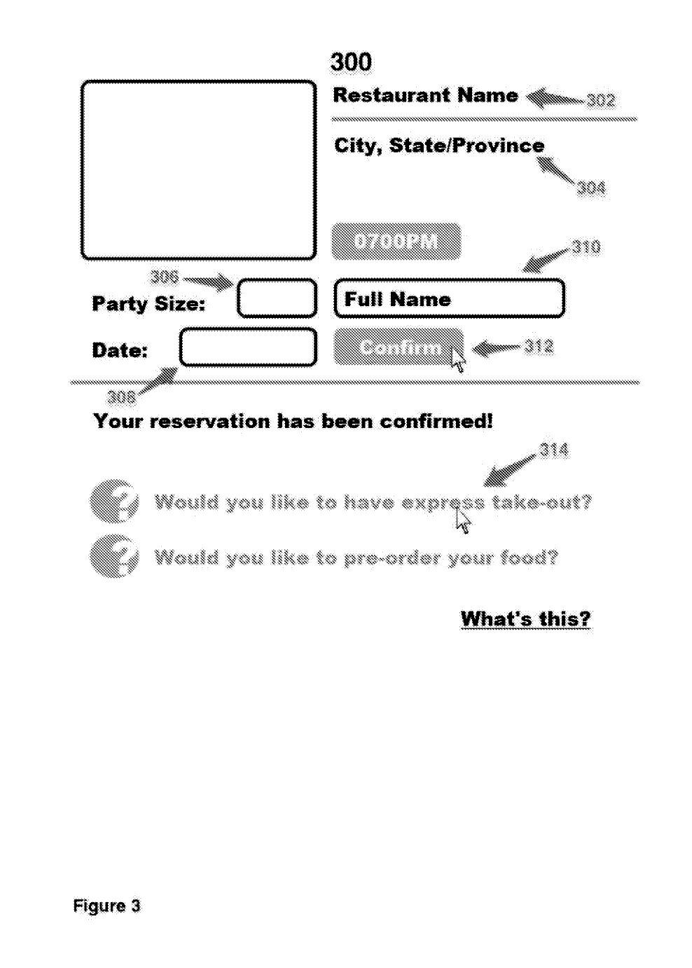

FIG. 3 illustrates a display screen 300 of an embodiment of an online restaurant system of the present invention, showing the screen after the customer has selected a reservation time on the display screen from FIG. 2. The customer is shown, on this display screen 300, the selected restaurant name 302, location 304, party size 306 and date 308, and is prompted to enter a name under which the reservation will be booked 310, and then confirm the reservation through confirmation button 312. Once the customer has done so, the online restaurant system may display a notice such as shown in display screen 300 informing the customer that the reservation has been confirmed. The online restaurant system then prompts the customer to pre-order their food for the reservation, as shown in FIG. 3 at 314.

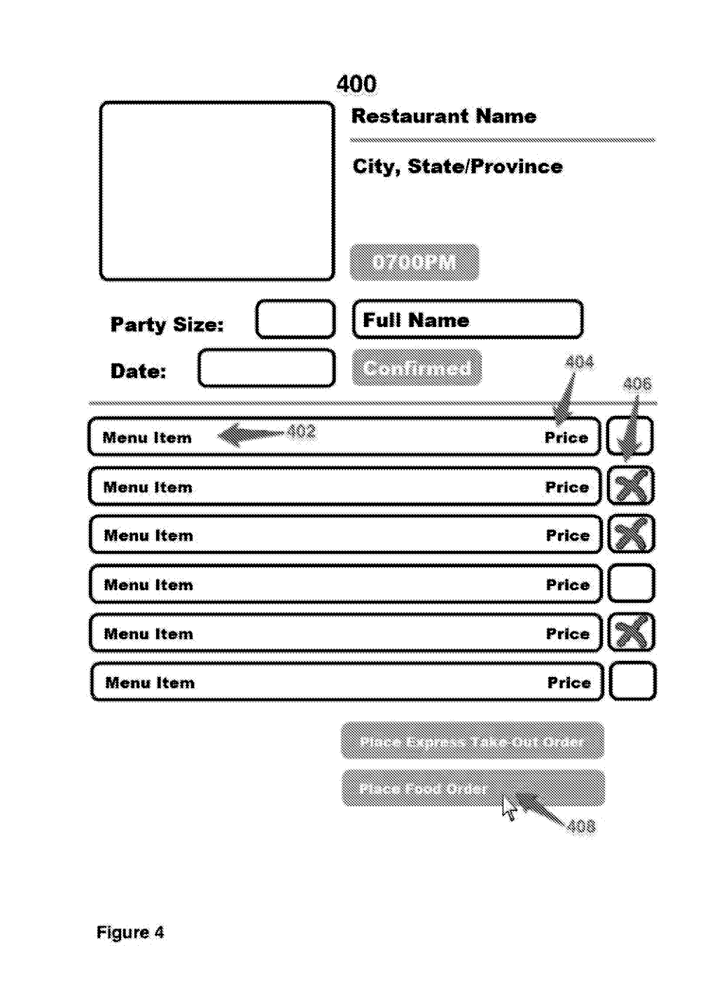

FIG. 4 illustrates a display screen 400 of an embodiment of an online restaurant system of the present invention, showing the screen after the customer has chosen to pre-order their food in the prior screen shown in FIG. 3. The present display screen 400 presents the customer with a list of available menu items 402 at the restaurant at which the reservation is being made, a price 404 for each item, and allows the customer to choose the menu items desired, which in the example display screen 400 is provided by check boxes 406 that can be activated by the customer. In display screen 400, the customer can then submit the food order as shown via the customer input button 408 labelled, in this FIG. 4, as “place food order”, although any suitable input method may be used for this purpose, including when no graphical widget is displayed and the customer simply submits the food order by, for example, keyboard input.

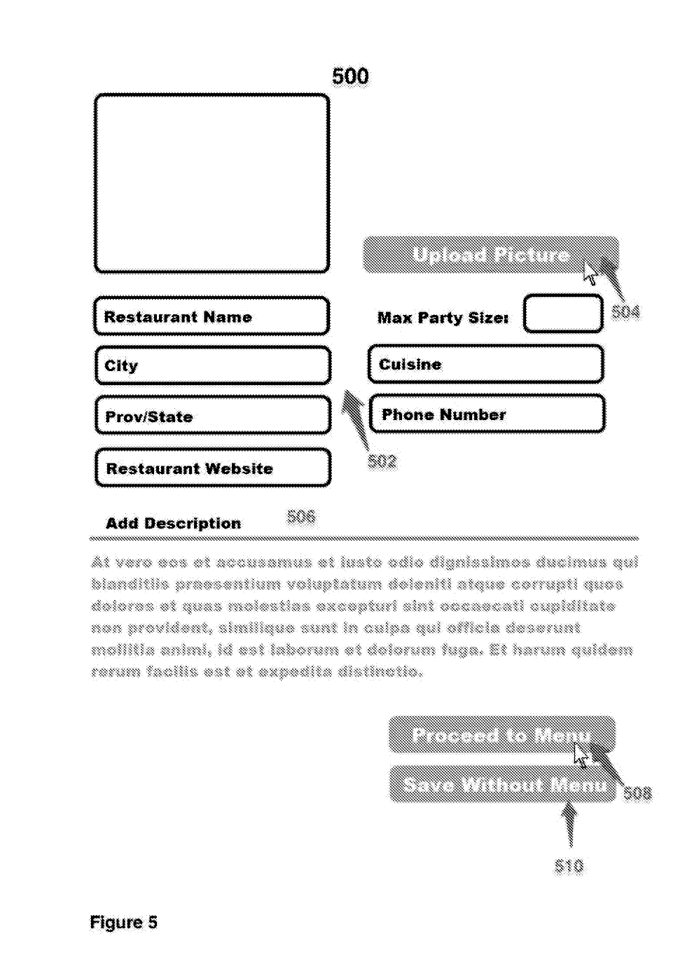

FIG. 5 illustrates a display screen 500 of an embodiment of an online restaurant system of the present invention, showing a screen which a proprietor of a restaurant would use to access their listing, or profile, in the online restaurant system database 112. On this screen, the restaurant customer is given a number of fields 502 through which he or she can edit the information related to that particular restaurant in database 112, such as, for example, restaurant name, city, province or state, website universal resource locator (or URL), maximum party size which can be accommodated at the restaurant, cuisine type, phone number, and can upload a picture 504 to be used in the restaurant profile. The invention is not limited to the items of information shown in FIG. 5, and any information desired could be entered into the database for use in the restaurant profile or to present to the customer as they use the system of the present invention. The restaurant user can also edit a description 506 of the restaurant to be used in the restaurant profile of the online restaurant system of the present invention. The display screen of FIG. 5 prompts the restaurant user to proceed to further screens in which they can add menu items to the online restaurant system 508, or save without submitting those items 510.

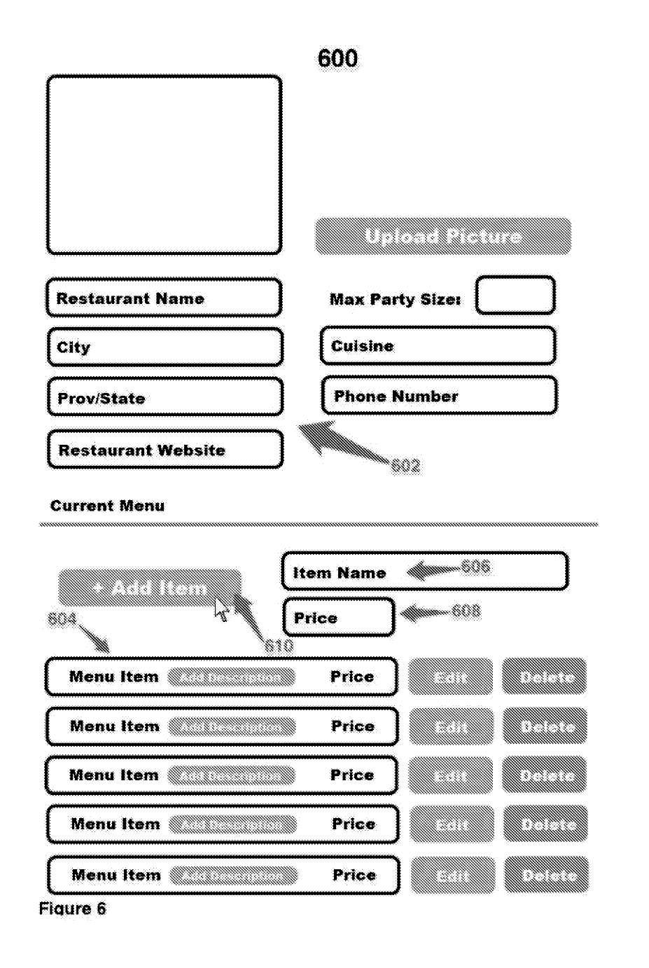

FIG. 6 illustrates a display screen 600 of an embodiment of an online restaurant system of the present invention, showing a screen which a proprietor of a restaurant, whose information is shown at the top 602 of display screen 600, would use to access their restaurant menu items 604 that are available to the customer to be pre-ordered. As shown in display screen 600, the restaurant user can choose to add a new item through text boxes for naming the menu items 606 and providing them a price 608, and then submit the information to the database 112 with submission button 610.

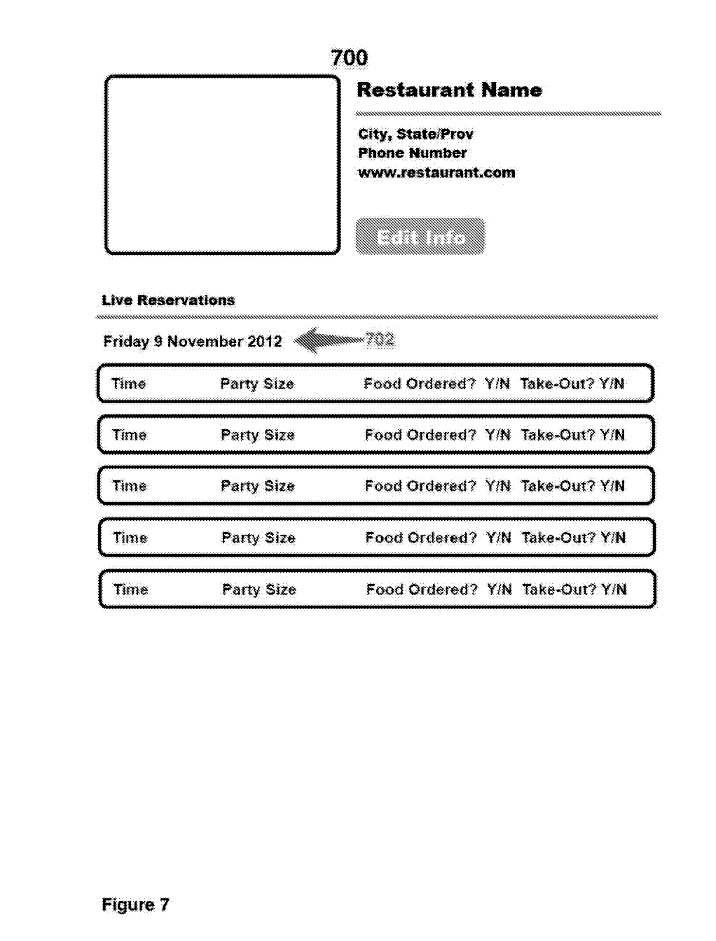

FIG. 7 illustrates a display screen 700 of an embodiment of an online restaurant system of the present invention, showing reservations 702 previously submitted through the online restaurant system at that particular restaurant, laid out for ease of reference by the restaurant user.

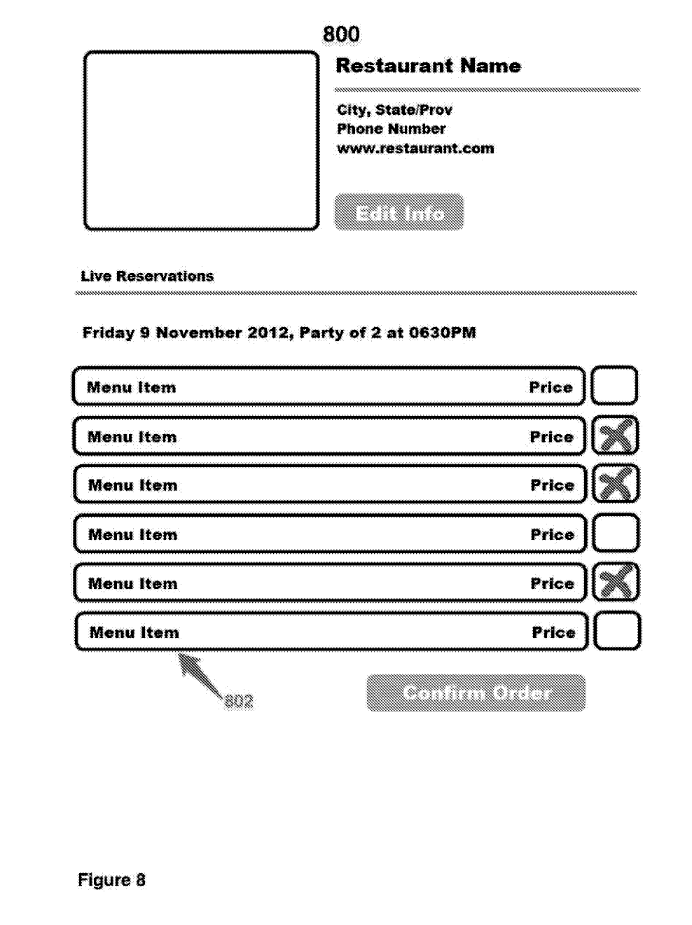

FIG. 8 illustrates a display screen 800 of an embodiment of an online restaurant system of the present invention, showing the menu items 802 selected for purchase for a particular reservation made at that restaurant.

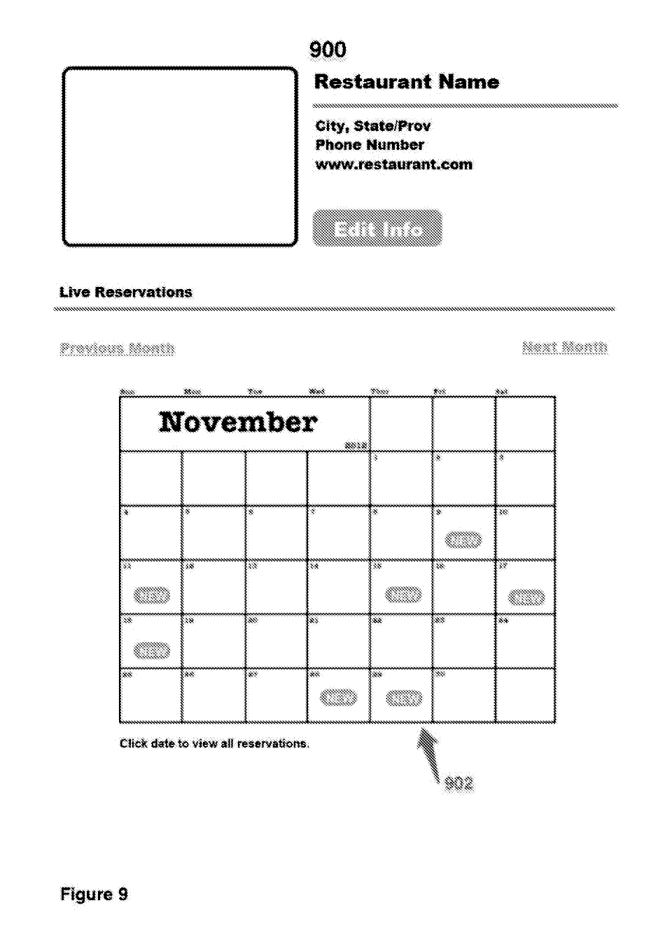

FIG. 9 illustrates a display screen 900 of an embodiment of an online restaurant system of the present invention, showing the reservations for the month of November on a monthly calendar 902.

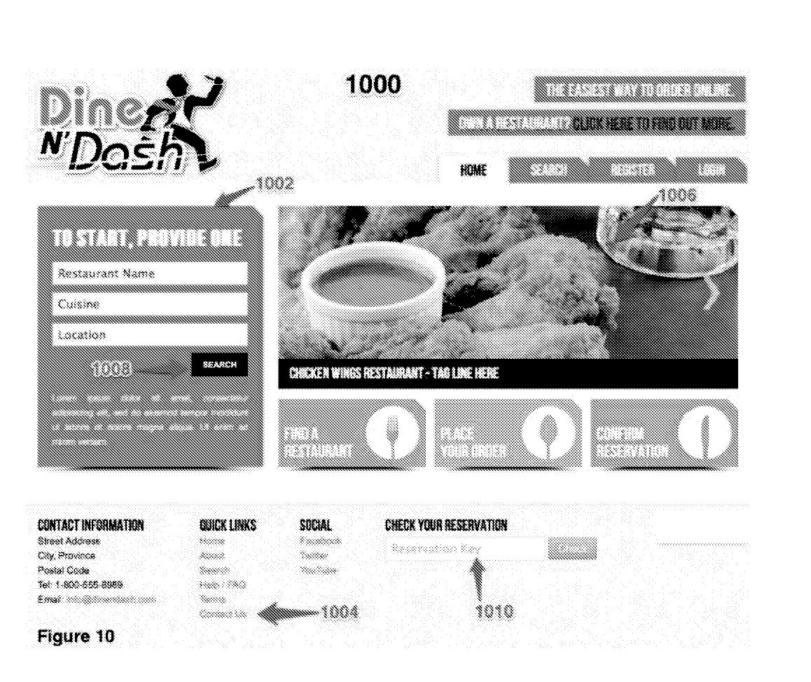

FIG. 10 illustrates a display screen 1000 of an embodiment of an online restaurant system of the present invention, similar to FIG. 2, showing a home screen to which a customer may be directed when first accessing the online restaurant system of the present invention. The search area (or “form”) 1002 allows the customer to search for suitable restaurants by various criteria using the various search fields provided, although any other search or selection widgets may be used in order to allow the customer to select or search suitable restaurants. Additional search fields beyond those shown in FIG. 10 may also be provided, allowing the customer to search by, for example, price, size of reservation, time of reservation, or any other information desired.

Optionally, announcements and other information, including advertisements, may be displayed to the customer on this display screen 1000, such as in the contact information 1004, or advertisement 1006. A search button 1008 submits the search to the online restaurant system, which queries a database of participating restaurants and information about those restaurants to return a list of suitable restaurants meeting the criteria submitted by the customer.

A prompt 1010 at the bottom of FIG. 10 prompts customers who have already accessed the system and been given a unique identification code (referred to as a “reservation key” in FIG. 10, and that may sometimes be called a “booking ID”) to input it in order to view, edit, or further amend their prior reservations.

Exemplary code to accept a booking ID from an HTML web page follows:

<form action=“http://localhost/x/reservations/check” method=“post”
id=“res_form”>
<input type=“text” value=“” name=“key” placeholder=“BOOKING ID”
class=“required” style=“width: 130px;”>
<input type=“hidden” value=“/x/” name=“url”>
<a href=“javascript:void(0)” class=“btn btn-primary” style=“color: #fff;”
onclick=“$(‘#res_form’).submit( );”>View</a>
</form>

Search area (or “form”) 1002 may be created by any programming language desired, and submitted to the online restaurant system by any networking protocol or by any networking messages desired. One exemplary way to allow search form 1002 to be submitted to the online restaurant web server of the invention is through HTML form submitting the data to a particular URL via the standard Internet “GET” method. This GET method is received and recognized by the online restaurant system, and causes that system to execute computer code that accepts the content of the search form and parses it into its constituents. Exemplary computer code to retrieve the search fields and parse the data contained therein follows:

```
if(isset($_GET[‘name’])) // since name is a required field, we check if the
form is submitted using the name field
      {
        // Retrieving of search fields
          $name = trim($_GET[‘name’]);
          $location = $_GET[‘city’];
          $cuisine = $_GET[‘cuisine’];
          $size = isset($_GET[‘max_party_size’]);
          $time = $_GET[‘time’];
          if($name)
          {
              $arr[‘LOWER(name) LIKE’] =
%’.trim(strtolower($name)).‘%’; /*user might search regardless of
alphabet cases so in order to match the cases we change both the request
and database value to lowercase with this code*/
          }
          if($location)
          {
              $arr[‘LOWER(city) LIKE’] =
              ‘%’.strtolower($location).‘%’;
          }
          if($cuisine)
          {
              $arr[‘LOWER(cuisine) LIKE’] =
              ‘%’.strtolower($cuisine).‘%’;
          }
          if($size)
          {
              if(!is_numeric($size))
              $size = 0;
              $arr[‘LOWER(max_party_size) >=’] =
              trim(strtolower($size));
          }
            $arr[‘active’] = 1;
            $page = $_GET[‘page’];
          // For the addition fields in search page
          if(isset($_GET[‘search’]) && $time!=“Time”)
          {
              $time=date(‘H:i:s’,strtotime($time.‘:00’));
              $time=strtotime($time);
              $data=array( );
              $data=$this->Restaurant-
>find(‘all’,array(‘conditions’=>$arr));
              $search=array( );
              foreach($data as $d)
              {
                $ti[ ]=$d[‘Restaurant’][‘reservation_start’];
              }
              $count=sizeof($ti);
              for($i=0;$i<$count;$i++)
              {
                $tim=strtotime($ti[$i]);
                $ti[$i]=$tim−$time;
                $ti[$i]=abs($ti[$i]);
              }
              $da=$ti;
              for($i=0;$i<$count;$i++)
              {
                for($j=$i+1;$j<$count;$j++)
                {
                    if($da[$i]>$da[$j])
                    {
                      $temp=$da[$i];
                      $da[$i]=$da[$j];
                      $da[$j]=$temp;
                    }
                }
              }
              for($i=0;$i<$count;$i++)
              {
                for($j=0;$j<$count;$j++)
                {
                    if($da[$i]==$ti[$j])
                    {
                    $search[$i]=$data[$j];
                    }
                }
              }
$this->set(‘search’,$search);
              $this->set(‘restaurantss’,$search);
          }
          else
          {
              $this->set(‘search’,$this->Restaurant-
>find(‘all’,array(‘conditions’=>$arr,‘limit’=>$page.‘,15’)));
      //Here restaurantss is set as variable in the view file for the fetched
restaurant meeting the user's criteria
              $this->set(‘restaurantss’,$this->Restaurant-
>find(‘all’,array(‘conditions’=>$arr,‘limit’=>$page.‘,15’)));
          }
          $this->set(‘count’,$this->Restaurant-
>find(‘count’,array(‘conditions’=>$arr)));// In order to display the number
of restaurants found
      }
```

Prompt 1010 is created, in the example of FIG. 10, through another web form which is similar to that as described for search form 1002. In this case, as previously described, a customer who has previously created a reservation on the system of the present invention and who has been given a unique identification code (reservation key), may enter that unique identification code in this web form and submit it to the online restaurant system. The online restaurant system will search for the unique identification code in the database in which all reservation information is stored. If found, it will retrieve the information of the reservation corresponding to this unique identification code and display it to the customer, for review, editing, printing, or any other suitable and desired action. A unique identification code created by a given user “A” may also be given to user “B”, and therefore allows user “B” to retrieve, review, edit, amend, or add to the reservation, as may be desired.

Exemplary code for creating such a web form by which the customer's entered unique identification key is sent to the online restaurant system of the invention, and checked by the online restaurant system of the invention for validity against the reservations stored in the system is provided below. The exemplary code shown below will display the reservation to the customer if a reservation under the unique identification key is found, and will display various error codes if the reservation is not found or if it has been cancelled.

//To retrieve the booking id
if(isset($_POST[‘key’]))

{

$k = trim($_POST[‘key’]);

}

//To check the validity of the booking id
if($r = $this−>Reskey−
>find(‘first’,array(‘conditions’=>array(‘reser_key’=>$k)))) //enter into
this condition only if the booking id is found

{
// To check if the reservation is already cancelled

$ca = $this−>Reservation−>findById($r[‘Reskey’][‘reser_id’]);

if($ca[‘Reservation’][‘cancelled’]==‘2’)
{

$this−>Session−>setFlash(“The host has already

cancelled the reservation.”);

$this−>redirect(‘/restaurants/reservation_key/0’);

}
else //if the reservation is not cancelled
{

$this−>set(‘resk’,$r);
$this−>set(‘key’, $k);

}

}
else
{

// if the booking id is not found

$this−>redirect(‘/restaurants/reservation_key/0/res_error’);

}

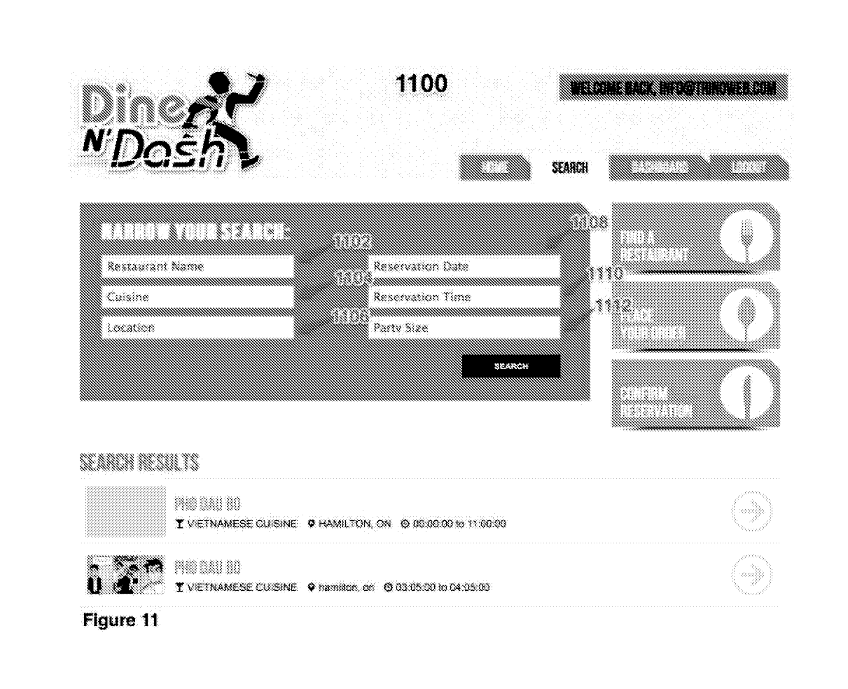

FIG. 11 illustrates a display screen 1100 of an embodiment of an online restaurant system of the present invention showing a more particular search screen than shown in FIG. 10, this screen having the ability to search by restaurant name 1102, cuisine 1104, location 1106, reservation date 1108, reservation time 1110, and party size 1112. Each search field populated by the customer is sent to the web application 104 of the present invention, and matched by the web application to entries in the database 112, if found. The search can be accomplished in any number of ways, but one particularly usable exemplary manner is to search through all fields in which the customer 100 has entered information, and provide search results for information from database 112 which matches all the information in the various fields provided by customer 100.

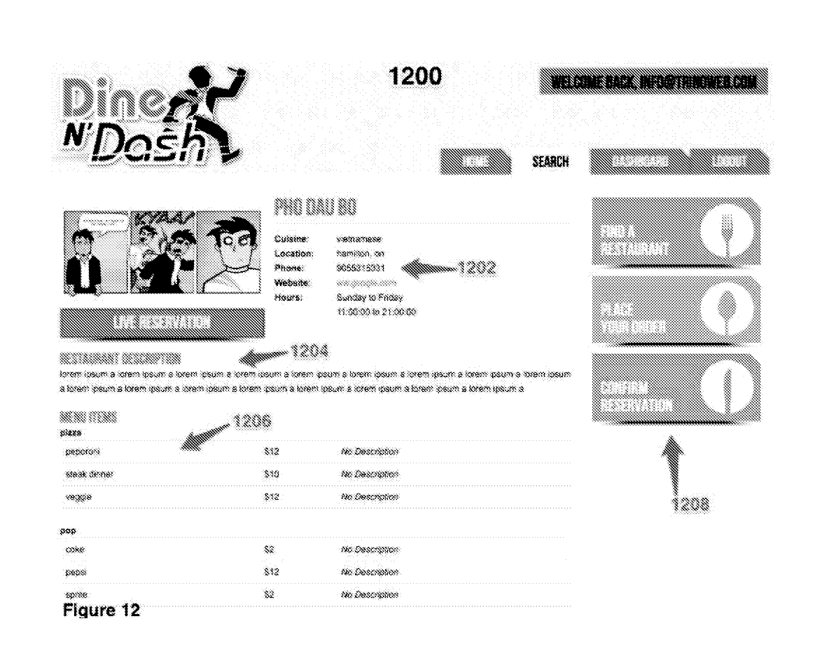

FIG. 12 illustrates a display screen 1200 of an embodiment of an online restaurant system of the present invention showing a particular restaurant profile, with in this embodiment address information 1202, description 1204, and menu items as well as their descriptions and prices 1206. Optionally, graphics may also be shown to the customer including advertisements, specials, restaurant promotions, sign-up messages, and the like, or links to other areas of the present system of the invention, such as shown in FIG. 12 as 1208.

Exemplary code to fetch restaurant information (such as description 1204) from the database 112 and store it in a variable, such as $res for instance, for display purposes, follows:

$res = $this−>Restaurant−
>find(‘all’,array(‘conditions’=>array(‘slug’=>$slug)));
$res_id = $res[0][‘Restaurant’][‘id’];

Exemplary code to fetch a restaurant's menu items (1206) and categories follows:

$cat = $this−>Menu_category−
>find(‘all’, array(‘conditions’=>array(‘res_id’=>$res_id)));

In this particular embodiment, menu categories are then used in the same function to fetch the menu items:

foreach($cat as $c)

{

$m = $this−>Menu−
>find(‘all’,array(‘conditions’=>array(‘res_id’=>$res_id,‘cat_id’=>$c[‘Menu_cat
egory’][‘id’], ‘featured’=>‘0’), ‘order’=>‘display_order ASC’));

if($m)
{

$ca[‘cat_id’][ ] = $c[‘Menu_category’][‘id’];
$ca[‘cat_title’][ ] = $c[‘Menu_category’][‘title’];
$count = count($ca[‘cat_id’])−1;
foreach($m as $me)
{

$menus[$count][‘id’][ ] = $me[‘Menu’][‘id’];
$menus[$count][‘price’][ ] =

$me[‘Menu’][‘price’];

$menus[$count][‘menu_item’][ ] =

$me[‘Menu’][‘menu_item’];

$menus[$count][‘description’][ ] =

$me[‘Menu’][‘description’];

$menus[$count][‘active’][ ] =

$me[‘Menu’][‘active’];

}

}

}
if(isset($menus))

{

$this−>set(‘cat’ ,$ca);
$this−>set(‘menu’,$menus);

}

The pdf menus are fetched using this code:
$this−>set(‘pdfs’,$this−>MenuPdf−
>find(‘all’,array(‘conditions’=>array(‘res_id’=>$res_id))));

Exemplary sample code creating in database 112 a table (see Table 1 below) containing restaurant information, the sample code showing the schema of such a table, is as follows:

CREATE TABLE IF NOT EXISTS ‘restaurants’ (

‘id’ int(11) NOT NULL AUTO_INCREMENT,
‘name’ varchar(255) NOT NULL,
‘street’ varchar(255) NOT NULL,
‘city’ varchar(255) NOT NULL,
‘prov_state’ varchar(255) NOT NULL,
‘latitude’ float NOT NULL,
‘longitude’ float NOT NULL,
‘website’ varchar(255) NOT NULL,
‘max_party_size’ int(255) NOT NULL,
‘cuisine’ varchar(255) NOT NULL,
‘style’ varchar(255) NOT NULL,
‘phone’ varchar(255) NOT NULL,
‘description’ text NOT NULL,
‘picture’ varchar(255) NOT NULL,
‘slug’ varchar(255) NOT NULL,
‘active’ int(11) NOT NULL DEFAULT ‘0’,
‘email’ varchar(255) NOT NULL,
‘password’ varchar(255) NOT NULL,
‘registered_on’ date NOT NULL,
‘day_open’ varchar(255) NOT NULL,
‘day_close’ varchar(255) NOT NULL,
‘time_open’ time NOT NULL,
‘time_close’ time NOT NULL,
‘reservation_start’ time NOT NULL,
‘reservation_end’ time NOT NULL,
‘HST’ varchar(255) DEFAULT NULL,
‘pos_zip’ varchar(255) DEFAULT NULL,
‘created’ datetime DEFAULT NULL,
‘modified’ datetime DEFAULT NULL,
‘fax’ int(11) DEFAULT NULL,
‘cell_phone’ varchar(255) DEFAULT NULL,
‘carrier’ varchar(255) DEFAULT NULL,
‘default_printer’ varchar(255) DEFAULT NULL,
‘default_printer_id’ varchar(255) DEFAULT NULL,
‘fax_true’ int(11) DEFAULT NULL,
‘sms_true’ int(11) DEFAULT NULL,
‘print_true’ int(11) DEFAULT NULL,
‘sunday’ text NOT NULL,
‘monday’ text NOT NULL,
‘tuesday’ text NOT NULL,
‘wednesday’ text NOT NULL,
‘thursday’ text NOT NULL,
‘friday’ text NOT NULL,
‘saturday’ text NOT NULL,
‘featured’ int(11) NOT NULL,
‘lunchtill’ time NOT NULL,
‘dinnertill’ time NOT NULL,
‘menutype’ int(11) NOT NULL DEFAULT ‘1’,
PRIMARY KEY (‘id’)

) ENGINE=InnoDB DEFAULT CHARSET=latin1
AUTO_INCREMENT=26 ;

TABLE 1
Sample data contained in a “restaurants” table

| | |
|---|---|
| id | 5 |
| name | x |
| street | x |
| city | Toronto |
| prov_state | Ontario |
| latitude | 42.6366 |
| longitude | −71.3974 |
| website | www.toronto.ca |
| max_party_size | 20 |
| cuisine | Japanese |
| style | |
| phone | |
| description | Fine Japanese |
| picture | 302.png |
| slug | |
| active | 1 |
| email | x@gmail.com |
| password | |
| registered_on | 0000-00-00 |
| day_open | Monday |
| day_close | Sunday |
| time_open | 00:00:00 |
| time_close | 00:00:00 |
| reservation_start | 19:00:00 |
| reservation_end | 19:00:00 |
| HST | NULL |
| pos_zip | NULL |
| created | 8/5/2013 23:08 |
| modified | 9/26/2013 15:35 |
| fax | NULL |
| cell_phone | 6.47E+09 |
| carrier | x@mms.telusmobility.com |
| default_printer | NULL |
| default_printer_id | NULL |
| fax_true | NULL |
| sms_true | 1 |
| print_true | NULL |
| sunday | 3 pm-11:00 pm |
| monday | 11 am-11:00 pm |
| tuesday | 11 am-11:00 pm |
| wednesday | 11 am-11:00 pm |
| thursday | 11 am-11:00 pm |
| friday | 11 am-11:00 pm |
| saturday | 12 pm-11:00 pm |
| featured | 0 |
| lunchtill | 00:00:00 |
| dinnertill | 00:00:00 |
| menutype | 1 |

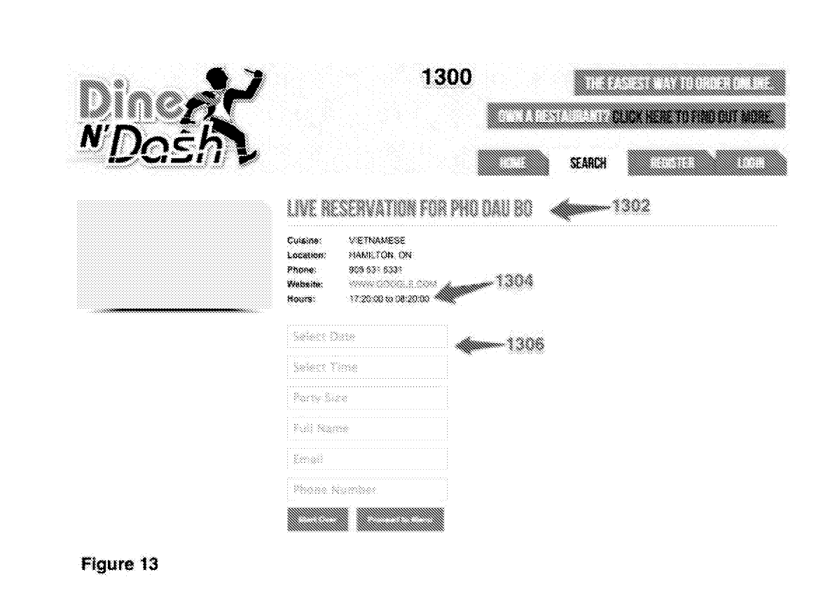

FIG. 13 illustrates a display screen 1300 of an embodiment of an online restaurant system of the present invention, showing a screen in which the customer may create a reservation booking with a restaurant 1302 for submission to that restaurant. Information relating to the restaurant, including hours within which reservations can be made, is shown at the top of the page 1304. The customer may enter information relating to the reservation to be created, 1306, to be relayed to the web application 104, including date, time, party size, full name, email, and phone number.

In this embodiment of the online restaurant system of the present invention, a particular reservation time has not been displayed and selected by the system, but instead the customer is prompted to enter a desired time for the reservation, which is sent to the web application 104 and from there to the restaurant for acceptance and confirmation.

Exemplary sample code to fetch restaurant information for display on the reservation booking screen of FIG. 13 follows.

$res = $this−>Restaurant−
>find(‘first’,array(‘conditions’=>array(‘slug’=>$slug))); // Here slug is
obtained from the url
$this−>set(‘res’,$res);

Furthermore, continuing the example code, after the customer places the desired value for the reservation, the following code is an example of what might be executed:

if(isset($_POST[‘submit’])) // Test if the user has submitted the form

{

$arr[‘res_id’] = $res[‘Restaurant’][‘id’];
$arr[‘reservation_date’] = date(‘Y-m-

d’,strtotime($_POST[‘reservation_date’]));

$arr[‘reservation_time’] =

date(‘H:i:s’,strtotime($_POST[‘time’].‘:00’));

```
$arr[‘party_size’] = $_POST[‘party_size’];
$arr[‘fullname’] = $_POST[‘full_name’];
$arr[‘email’] = $_POST[‘email’];
$this−>Session−>write(‘reser_email’,$arr[‘email’]);
$arr[‘phone’] = $_POST[‘phone_number’];
  if(isset($reser_id))
  {
```

$this−>Reservation−>id=$reser_id;
foreach($arr as $k=>$v)
{

$this−>Reservation−>saveField($k,$v); // this is to

save the reservation made by the user if the user is editing the already
made reservation

}

```
  }
  else
  {
```

$this−>Reservation−>create( );
$this−>Reservation−>save($arr); // This is to make a brand

new reservation

$this−>Session−>write(‘reser_id’, $this−>Reservations id);

```
  }
    // To make necessary redirects after the reservation is made
  if(isset($_POST[‘reserve_id’]) &&
  $_POST[‘reserve_id’]!=‘’)
  {
```

$this−

>redirect(‘reservation_edit/’.$slug.‘/’.$_POST[‘reserve_id’]);

```
  }
  else
  {
```

$this−>redirect(‘reservation_success/’.$slug.‘/’.$this−

>Reservation−>id);

}

}

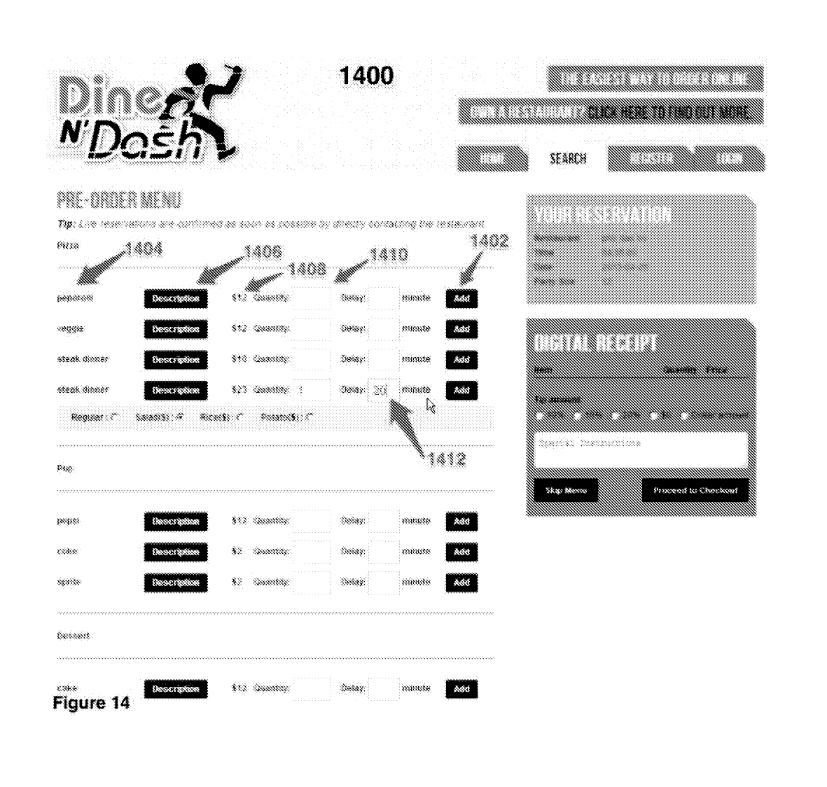

FIG. 14 is an example of a display screen of an online restaurant system of the present invention in which a customer is selecting menu items 1402 that he or she wishes to order from the restaurant as a pre-order for the reservation meal being booked. Menu items 1404 are displayed, buttons provided 1406 by which the customer may obtain more information relating to the menu items, as well as prices of each menu item 1408. The customer is prompted to enter the quantity of each desired menu item 1410.

Particularly relevant to the present invention is that the customer is prompted to enter a delay 1412 which is the time after the start of the reservation when the customer wishes that menu item to be served. This information is sent to the restaurant so that the menu items can be prepared well enough in advance of the desired service time to allow the menu items to meet the customer's expectations. Therefore, as an example, a reservation that starts at 8 pm might have a delay on the main course of 30 minutes, indicating that the customer 100 desires that portion of their meal to be served 30 minutes after arrival at the restaurant.

In an alternate embodiment, the delay field would represent a time delay after the previous menu item was served, and would not be measured from the start of the reservation. Alternately, the delay field could be any other appropriate measure of time by which a customer and any reservation guests could provide the system of the present invention with information about when they wish their menu items to be served (i.e. all times delayed after a particular course, etc.)

The input of the delay field can be effected by an input field, for example, and exemplary code to provide such an input field (including HTML as well as the underlying PHP code) is as follows:

<td width=“32%”>

&nbsp; Served In :<a class=“icon-question-sign popdesc”

rel=“popover”></a>
<select name=“delay” style=“width: 92px;” id=“delay_<?php echo
$m[‘Menu’][‘id’];?>”><option value=“”>Select Minutes</option><?php
for($i=15;$i<=60;$i=$i+15){?><option value=“<?php echo $i;?>”><?php
echo $i;?>
Minutes</option><?php }?></select>
</td>

Continuing this example, exemplary code that would process this input field and save the “delay” value to a database follows, using the PHP language:

$selected = trim(str_replace(‘, ’, ‘&&’,,$_POST[‘selected_item’]));
$mix = str_replace(‘&&’, ‘,’$selected);
$arr = explode(‘, ’,$mix);
$ids = ‘’;
$qts = ‘’;
$prs = ‘’;
$cmp = ‘’;
$dly = ‘’;
for($1=0;$i<count($arr);$!++)
{
if($arr[$i]!= ‘’ && $arr[$i] != ‘0’)

{
$arr2 = explode(‘_’,$arr[$i]);
$ids = $ids.$arr2[0].‘,’;
$qts = $qts.$arr2[l].‘,’;
$prs = $prs.$arr2[2].‘,’;
$cmp = $cmp.$arr2[3].‘,’;
$dly = $dly.$arr2[4].‘,’;
}

}
$tot=$_POST[‘tot’];
$tot=floatval($tot);
$option=$_POST[‘wing’];
$tax=$_POST[‘vat’];
$discount =$_POST[‘discount’];
$discount = floatval($discount);
$tax=floatval($tax);
$g_tot=$_POST[‘g_tot’];
$g_tot=floatval($g_tot);
$tips=$g_tot−$tot−$tax;
$tips_type = $_POST[‘tips_type’];
$tips_amount = $_POST[‘tips_value’];
$ids = trim(str_replace(‘,’, ‘ ’,$ids));
$ids = str_replace(‘ ’,‘,’,$ids);
$qts = trim(str_replace(‘,’, ‘ ’,$qts));
$qts = str_replace(‘ ’,‘,’,$qts);
$prs = trim(str_replace(‘,’, ‘ ’,$prs));
$prs = str_replace(‘ ’, ‘, ’,$prs);
$cmp = trim(str_replace(‘,’, ‘_{——}’,$cmp));
$cmp = str_replace(‘_{——}’, ‘,’ ,$cmp);
$dly = trim(str_replace(‘, ’, ‘ ’,$dly));
$dly = str_replace(‘ ’,‘,’,$dly);
$this−>Reservation−>id = $id;
if($ids!=“”)
{
$this−>Reservation−>saveField(‘menu_ids’,$ids);
$this−>Reservation−>saveField(‘qtys’,$qts);
$this−>Reservation−>saveField(‘prs’,$prs);
$this−>Reservation−>saveField(‘cmp’,$cmp);
$this−>Reservation−>saveField(‘delays’,$dly);
$this−>Reservation−>saveField(‘total’,$tot);
$this−>Reservation−>saveField(‘tips’,$_POST[‘tips_id_van’]);
$this−>Reservation−>saveField(‘tax’,$tax);
$this−>Reservation−>saveField(‘discount’,$discount);
$this−>Reservation−>saveField(‘g_total’,$g_tot);
$this−>Reservation−>saveField(‘wings’,$option);
$this−>Reservation−>saveField(‘tips_type’,$tips_type);
$this−>Reservation−>saveField(‘tips_value’,$tips_amount);
$this−>Reservation−>saveField(‘special_notes’,$_POST[‘special_notes’]);
}

In an alternate embodiment of the present invention the customer 100 (or a reservation guest) may select an actual time for delivery of the particular menu items, rather than a delay amount. In this embodiment, the field 1412 in FIG. 14, called “delay”, would be replaced by a field named “time”, and the calculations to be sent to the restaurant would be adjusted accordingly to ensure that the menu items were delivered to the customer (or reservation guest) at the particular time.

In a further embodiment of the present invention, the customer 100 may select an end time for the reservation, representing a time by which they wish to have finished eating and left the restaurant. This then may be used by the restaurant to co-ordinate both service times of the various menu items to be served, as well as co-ordinate the service of the bill and collection of any payment from the customer and any reservation guests.

In a preferred embodiment of the present invention, the web server sends notifications to the restaurant, reminding the restaurant to serve the menu items at the appropriate time as expressed by the customer, as described elsewhere herein.

In a further preferred embodiment, the restaurant users have input the amount of preparation time required for each of the various menu items input into the web application of the present invention. The web application, knowing the reservation time as set by the customer, the delay desired on each particular menu item, and the preparation time required to prepare that particular menu item, can then calculate and send additional notifications to the restaurant to start preparing each menu item so that it can be ready and be served at the customer's desired time. This clearly results in increased efficiency and customer good-will, as the menu items are prepared in a “just in time” basis for deliver to the customer at the desired times.

Exemplary code to fetch the related restaurant information follows.

$res = $this−>Restaurant−
>find(‘first’,array(‘conditions’=>array(‘slug’=>$slug)));

Continuing the example, example code to then determine whether the menu belongs to dinner, lunch, or both follows.

if(isset($_GET[‘both’]))

{

$category = $this−>Menu_category−

>find(‘all’,array(‘conditions’=>array(‘res_id’=>$res[‘Restaurant’][‘id’]),‘ord
er’=>‘‘order’’));

}
elseif(isset($_GET[‘lunch’]))
{

$category = $this−>Menu_category−

>find(‘all’,array(‘conditions’=>array(‘res_id’=>$res[‘Restaurant’][‘id’],‘OR’=
>array(array(‘cattype’=>1),array(‘cattype’=>0))),‘order’=>‘‘order’’));

$this−>set(‘lun’,‘1’);

}
elseif(isset($_GET[‘dinner’]))
{

$category = $this−>Menu_category−

>find(‘all’,array(‘conditions’=>array(‘res_id’=>$res[‘Restaurant’][‘id’],‘OR’ =
>array(array(‘cattype’=>2),array(‘cattype’=>&))),‘order’=>‘“order”’));

$this−>set(‘din’,‘1’);

}
else
{

$category = $this−>Menu_category−

>find(‘all’,array(‘conditions’=>array(‘res_id’=>$res[‘Restaurant’][‘id’],‘OR’=
>array(array(‘cattype’ = >1),array(‘cattype’=>0))),‘order’=>‘‘order’’));

}

$this−>set(‘category’,$category);

Example code to determine what extra items ought to be displayed to the customer follows.

$this−>set(‘ext’,$this−>Extra);
$this−>set(‘menu’,$this−>Menu−>find
(‘all’,array(‘conditions’=>array(‘res_id’=>$res[‘Restaurant’][‘id’]),‘order’=>
‘display_order’)));

Example code to retrieve the reservation details (date, time, contact number, part size, etc.) for display purposes, as shown on the right-hand side of FIG. 14, follows:

$this−>set(‘reser’, $this-Reservation−
>find(‘first’,array(‘conditions’=>array(‘id’=>$id))));

Exemplary sample code creating in database 112 a table (see Table 2 below) containing these menu items, the sample code also showing the schema for such a table, is as follows:

CREATE TABLE IF NOT EXISTS ‘menus’ (

‘id’ int(11) NOT NULL AUTO_INCREMENT,
‘cat_id’ int(11) NOT NULL DEFAULT ‘1’,
‘res_id’ int(11) NOT NULL,
‘menu_item’ varchar(255) NOT NULL,
‘description’ text NOT NULL,
‘price’ varchar(255) NOT NULL,
‘display_order’ int(11) NOT NULL,
‘featured’ int(11) NOT NULL,
‘active’ int(11) NOT NULL DEFAULT ‘1’,
‘has_complimentary’ int(11) NOT NULL DEFAULT ‘0’,
‘has_regular’ int(11) NOT NULL DEFAULT ‘0’,
‘image’ varchar(255) NOT NULL,
‘type’ int(11) NOT NULL COMMENT ‘1:veg 2:spicy’,
‘is_multiple’ int(11) NOT NULL,
PRIMARY KEY (‘id')

) ENGINE=InnoDB DEFAULT CHARSET=latin1
AUTO_INCREMENT=1256 ;

TABLE 2
Sample data contained in a “menus” table

| | | | | | | | | | | | | | |
|---|---|---|---|---|---|---|---|---|---|---|---|---|---|
| | | | menu_{—} | descrip- | | dis- | fea- | | has_compli- | has_reg- | | | is_mul- |
| id | cat_id | res_id | item | tion | price | play_order | tured | active | mentary | ular | image | type | tiple |

| | | | | | | | | | | | | |
|---|---|---|---|---|---|---|---|---|---|---|---|---|
| 1 | 1 | 1 | cola | 6.99 | 3 | 1 | 1 | 1 | 0 | 008.jpg | 1 | 0 |
| 2 | 1 | 1 | water | 1.99 | 1 | 0 | 1 | 0 | 0 | | 0 | 0 |
| 3 | 1 | 1 | tea | 3.99 | 2 | 0 | 1 | 0 | 0 | | 0 | 0 |
| 4 | 2 | 1 | steak | 18.99 | 1 | 1 | 1 | 1 | 0 | | 1 | 0 |

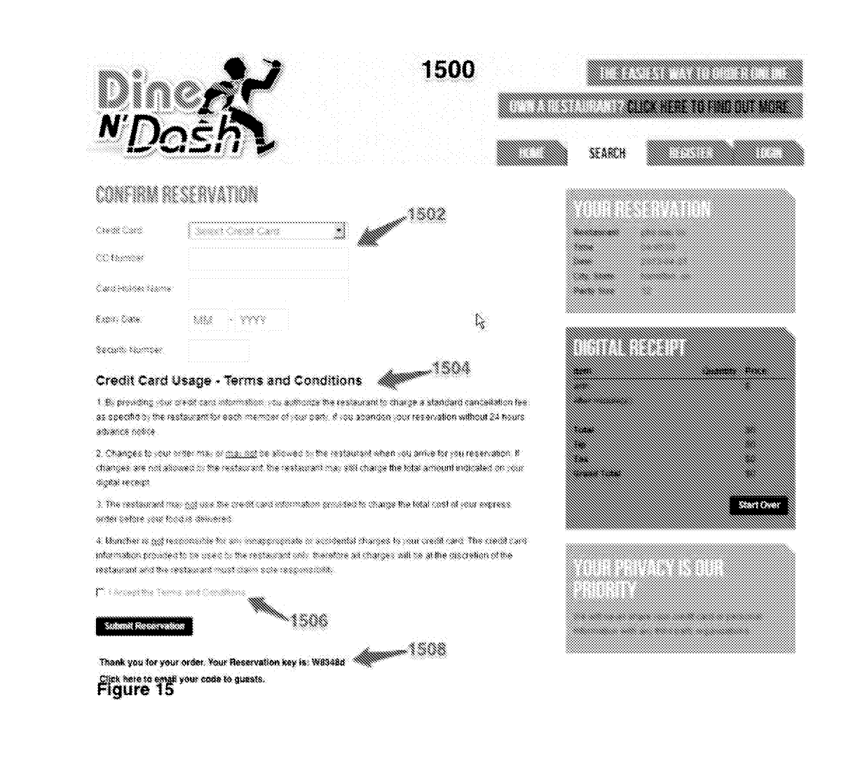

FIG. 15 is an example of a display screen of an online restaurant system of the present invention in which a customer is confirming a reservation previously submitted to the system. In the embodiment presented in FIG. 15, the customer is being prompted to enter his or her credit card information 1502, including number, name and expiry date. Terms and conditions are displayed 1504, and the customer is prompted to acknowledge them with an input mechanism, in this case a check box 1506.

Once the confirmation has been received by the web application, the system generates and presents to the customer a unique identification code 1508, which can be used by the customer or others to access the reservation and make changes thereto, as for example through an input field as shown in FIG. 10 at 1010.

At some point after entering the reservation, the online restaurant system of the present invention can ask the customer creating the booking for the e-mail addresses of the various attendees (or guests) of the reservation. A particularly preferred embodiment of the present invention then communicates the unique identification code 1508 to the various guests in order that they might visit the web server of the present invention, enter the code, and add their own meal orders. This communication can be accomplished in any number of known ways including without limitation e-mail, SMS message, automated telephone call or voice recording, and the like. Sample code demonstrating how the various e-mail addresses of the attendees are retrieved from the reservation table in the database 112, and how an e-mail communication might be created which would be sent to these attendees follows.

$em = $_POST[‘em’]; //In order to fetch the comma seperated email
values

$id = $_POST[‘reser_id’]; // In order to get the reservation id
$rand = $_POST[‘rand’]; // In order to get the booking id
$q_reservation = $this−>Reservation−>findById($id); // using

reservation id the reservation detail is fetched using this code

$res_id = $q_reservation[‘Reservation’][‘res_id’]; // to get the

restaurant id from the associated reservation id

$this−>Restaurant−>id = $res_id; // To fetch the restaurants
detail

$current_restro = $this−>Restaurant−>read( );

// These are the url to be sent out in the email so that user can click

on it to go to the required page

```
  $url2 = ‘http://www.x.ca/reservations/check/’.$rand;
  $url1 = ‘http://www.x.ca’;
```

$this−>loadModel(‘Reservation’);
$arr = explode(‘,’,$em); // this is to separate comma seperated

emails to individual emails in an array

$self = $_POST[‘self’]; // this is the self email
if($self)
{

$arr[ ] = $self;

}
$msg = $_POST[‘msg’];
$title = $_POST[‘title’];
$ok = 0;

// This is to loop through each comma separated emails to send each one
a copy of invitation

for($i=0;$i<count($arr);$i++)
{

if(trim($arr[$i])!= “”)
{

if($_SERVER[‘SERVER_NAME’]==‘localhost’)
{

$url = ‘http://localhost/x/img/’;

}
else
{

$url = ‘http://x.ca/img/’;

}
$q = $this−>Reservation−

>find(‘first’,array(‘conditions’=>array(‘id’=>$id)));

$fullname = $q[‘Reservation’][‘fullname’];
$from = (array(‘info@x.ca’ => ‘x’));
$to = (trim($arr[$i]));
$sub = (“You're invited to an event!”);
$msg = (“<div style=‘ overflow: hidden; background:
#fff;

margin: 0 auto; max-width: 700px; padding: 10px; text-align: center; -
webkit-border-radius: 5px; -moz-border-radius: 5px; border-radius: 5px; -
webkit-box-shadow: rgba(0,0,0,0.2) 0px 1px 3px; -moz-box-shadow:
rgba(0,0,0,0.2) 0px 1px 3px; box-shadow: rgba(0,0,0,0.2) 0px 1px
3px;font-
family: Georgia, serif;font-size:18px;border:2px solid
#c1c1c1;color:#222;’>

<img src=‘“.$url.”g1.jpg’ style=‘width:80px;
float:left;’ />
<img src=‘“.$url.”g2.jpg’ style=‘width:80px;
float:right;’ />
<br>
<center>
<img src=‘http://x.ca/img/logo_color.png’ />
</center>
<br><br>
Who?<br>
<b>Hosted by
“.$q_reservation[‘Reservation’][‘fullname’].”
</b><br><br>
Where?
<br>
<b>
“
.$current_restro[‘Restaurant’][‘name’].“, ”
.$current_restro[‘Restaurant’][‘street’].“, ”
.$current_restro[‘Restaurant’][‘city’] .“ ”
.$current_restro[‘Restaurant’][‘prov_state’].“ ”
.$current_restro[‘Restaurant’][‘pos_zip’]
.”
</b>
<br><br>
When?
<br>
<b>
“
.$q_reservation[‘Reservation’][‘reservation_date’].“
at ”
.date (‘g:i

A’,strtotime($q_reservation[‘Reservation’][‘reservation_time’]))

.”
</b><br><br>
~
<br>
Log into <a href=‘“.$url1.”’>www.x.ca</a> with
booking ID:

<b><u>“.$rand.”</u></b>

<br>
or
<br>
Click <a href=‘“.$url2.”’>here</a> to make your
order now.<br>
~
<br><br>
Special Message from the Host:
<br>
<span style=‘padding:0 20px;font-

weight:bold;’>“.stripslashes(nl2br($msg)).”

</span>
<br><br>
-The Team
<br>
<img src=‘“.$url.”g3.jpg’ style=‘width:80px;
float:left;’ />
<img src=‘“.$url.”g4.jpg’ style=‘width:80px;
float:right;’ />
</div>
”);
AppController::Send_Email($from,$to,$sub,$msg);

unset($from,$to,$sub,$msg);

$ok = 1;

}

}
$this−>Session−>setFlash(“Invitation(s) sent successfully.

Thank you for using our system!”);

echo $ok;
die( );

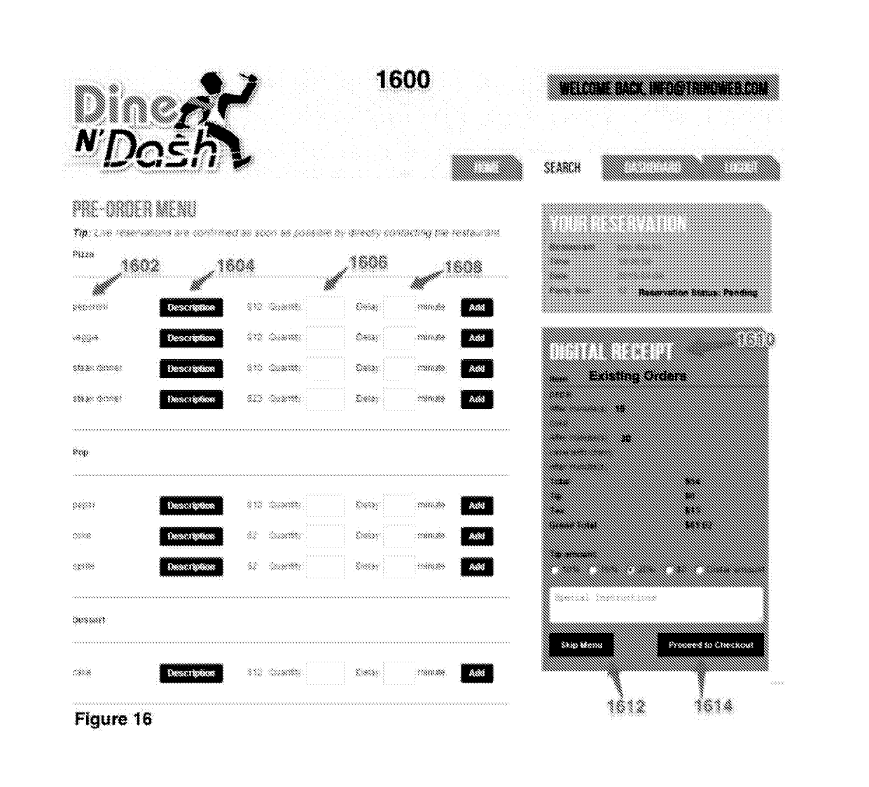

FIG. 16 is an example of a display screen of an online restaurant system of the present invention in which a reservation is being accessed after it has already been placed, the reservation being accessed through the use of the unique identification code 1508 shown and described in relation to FIG. 15. Much of FIG. 16 is similar to FIG. 14, showing the menu items 1602 ordered, description buttons 1604, quantities 1606, and desired delay times 1608. A receipt 1610 to the right of the order area shows the existing menu items ordered in the reservation, as well as tip, tax and grand total for the reservation as a whole. Inputs to skip food selection 1612 and to check-out 1614 are provided.

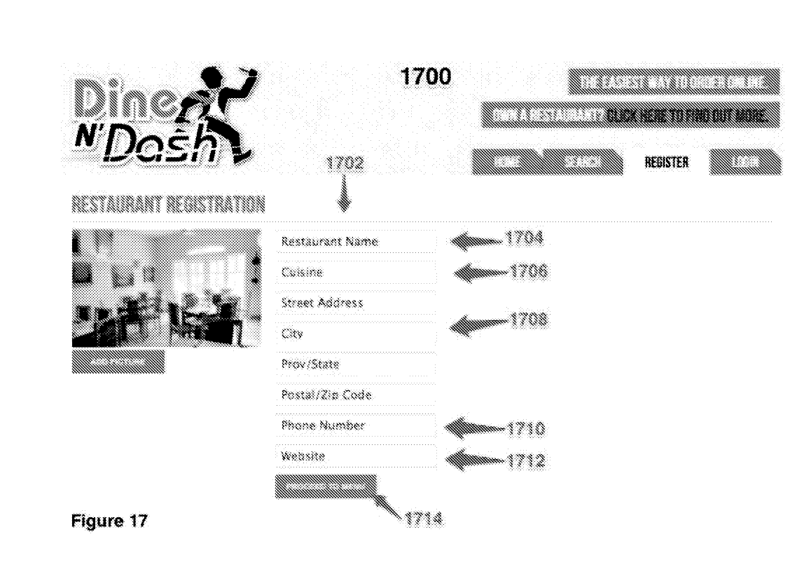

FIG. 17 is an example of a display screen of an online restaurant system of the present invention showing the input fields 1702, including restaurant name 1704, cuisine type 1706, various address fields 1708, phone number 1710 and website address 1712. The information found in these form fields can be submitted to the web application through an input mechanism, in this case button 1714, although any other input mechanism would also be suitable.

Exemplary code to retrieve the user-submitted restaurant values, including name, address, cuisine type, web site address, and associated images follows.

$arr[‘name’] = $_POST[‘name’];

$arr[‘street’] = $_POST[‘street’];
$arr[‘prov_state’] = $_POST[‘prov’];
$arr[‘city’] = $_POST[‘city’];
$arr[‘cuisine’] = $_POST[‘cuisine’];
$arr[‘website’] = $_POST[‘website’];
$arr[‘pos_zip’] = $_POST[‘pos_zip’];
$arr[‘latitude’] = $_POST[‘latitude’];
$arr[‘longitude’] = $_POST[‘longitude’];
$arr[‘reservation_start’] = $_POST[‘reservation_start’];
$arr[‘reservation_end’] = $_POST[‘reservation_end’];
$arr[‘reservation_start’] =

date(‘H:i:s’,strtotime($arr[‘reservation_start’].‘:00’));

$arr[‘reservation_end’] =

date(‘H:i:s’,strtotime($arr[‘reservation_end’].‘:00’));

$arr[‘HST’]=$_POST[‘hst’];
$arr[‘phone’] = $_POST[‘phone’];

// create a unique slug for the restaurant

$pattern = ‘/[\hat{ }a-zA-Z0-9-’ . $whiteSpace . ‘]/u’;
$cleared = preg_replace($pattern, ‘’, (string) $arr[‘name’]);
$conditions = $this−>postConditions(array(‘slug’=>$cleared));

$ch = $this−>Restaurant−
>find(‘all’,array(‘conditions’=>array(‘slug’=>$cleared)));

if(empty($ch))
{

$arr[‘slug’] = $cleared;

}
$arr[‘picture’] = $_POST[‘picture’][0]; // Retrieve main image

of the restaurant

$this−>Restaurant−>create( );
$this−>Restaurant−>save($arr); // Save the Restaurant to the

database

$arrs[‘res_id’] = $this−>Restaurant−>id;
if(!isset($arr[‘slug’]))
{

$id = $this−>Restaurant−>id;
$this−>Restaurant−>read( );
$arr[‘slug’] = $cleared.‘-’.$id;
$this−>Restaurant−>save(array(‘slug’=>$arr[‘slug’])); //

save associated slug

$arrs[‘res_id’] = $this−>Restaurant−>id;

}

// Save all other images to the database for the restaurant

if(count($_POST[‘picture’])>0)
{

$this−>loadModel(‘Image’);
for($i=0;$i<=(count($_POST[‘picture’])−1);$i++)
{

$arrs[‘images’] = $_POST[‘picture’][$i];
if($arrs[‘images’])
{

$this−>Image−>create( );
$this−>Image−>save($arrs);

}

}

}

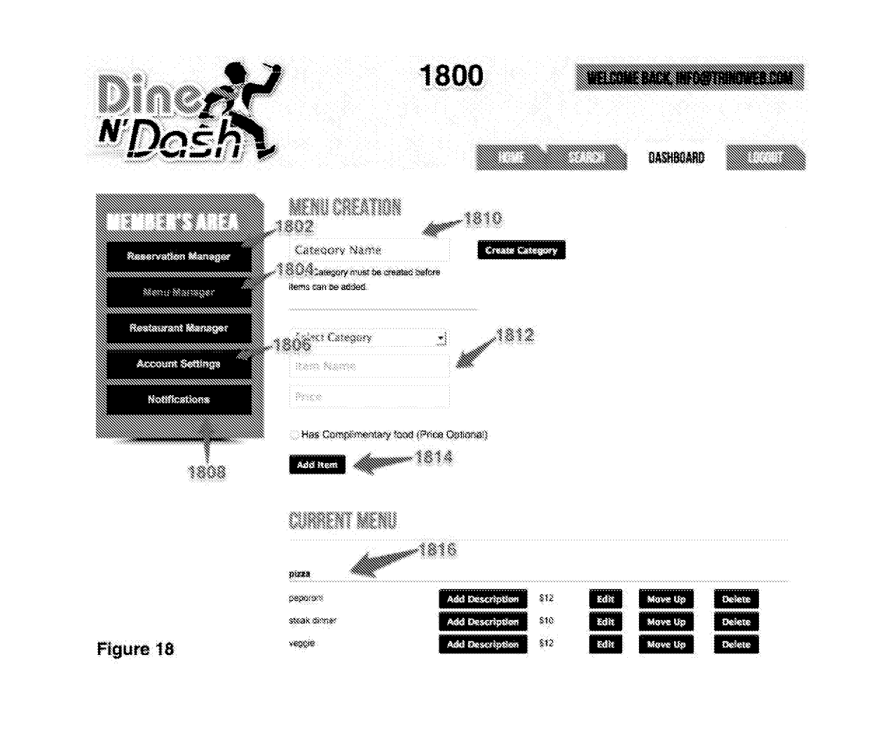

FIG. 18 is an example of a display screen of the restaurant back-end of the online restaurant system of the present invention, which the restaurant users who have created profiles or accounts with the online restaurant system of the invention may use to track reservations made at their restaurants 1802, manage their menus 1804, change account settings 1806, and change their notification settings 1808. In the display shown in FIG. 18, the restaurant user is in the midst of creating a menu that will be presented to customers and users of the online restaurant system of the present invention. Items for a given menu category 1810 are entered in text fields 1812, and once submitted using the “Add Item” button 1814, will display at the bottom of FIG. 18 alongside the existing menu items 1816. Items are populated and stored in the database 112 of the present system by software calls to the database system, as would be known by the person of skill in the art. Exemplary code to create a menu category, as input in input field 1810, and save the category to the database 112, follows.

// Slug is obtained from the url which determines the restaurant associated
with the menu
if($slug)

{

$res = $this−
>Restaurant>find(‘first’,array(‘conditions’=>array(‘slug’=>$slug)));
$res_id = $res[‘Restaurant’][‘id’]; // obtaining restaurant id using slug

}
else
{

$res_id = $this−>Session−>read(‘res_id’); // if the slug is not

found we use the id saved in the session to identify the restaurant

}
$cat[‘res_id’] = $res_id; // assigning restaurant id to category table

of database

$cat[‘title’] = $_POST[‘cat’]; // retrieving the category name

inserted by the user

$cat[‘description’] = $_POST[‘description’]; // Retrieving the

category description

// This is to assign the display order to the newly created menu

category

$q = $this−>Menu_category−>find(‘first’,

array(‘conditions’=>array(‘res_id’=>$res_id), ‘‘order’=>‘‘order’
DESC’));

if($q)
{

$order = $q[‘Menu_category’][‘order’];

}
else
{

$order = 1;

}
$order++;
$cat[‘order’]=$order;

// Saving the newly created menu to the database

$this−>Menu_category−>create( );
$this−>Menu_category−>save($cat);
$this−>Session−>setFlash(‘Category successfully created!’);

Exemplary code for the subsequent step of retrieving the information submitted by the customer/user in the menu creation form follows.

// Retrieving the menu values from the form
arr[‘cat_id’] = $_POST[‘data’][‘Menu’][‘cat_id’]; // get associated
category for the chosen menu
$arr[‘res_id’] = $id; // get associated restaurant of the menu (from URL)
$arr[‘menu_item’] = $_POST[‘data’][‘Menu’][‘menu_item’]; //This is to
retrieve the menu item name
$arr[‘price’] = $_POST[‘data’][‘Menu’][‘price’]; //This is to retrieve the
menu item price
// Ordering the menu by assigning the display order

$ord = $this−>Menu−

>find(‘first’,array(‘conditions’=>array(‘cat_id’=>$arr[‘cat_id’],
‘res_id’=>$arr[‘res_id’]), ‘order’=>‘display_order DESC’));

if($ord)
{

$arr[‘display_order’] = $ord[‘Menu’][‘display_order’]+1;

}
else
{

$arr[‘display_order’] = 1;

}

// Saving the menu to the database

if($this−>Menu−>save($arr))
{

if(isset($_POST[‘data’][‘Menu’][‘has_complimentary’]))
{

$this−>Menu−>saveField(‘has_complimentary’, ‘1’);

}
$arr[‘menu_id’] = $this−>Menu−>id;

// Saving extra fields associated to the menu

if(isset($_POST[‘title’]))
{

$this−>Menu−>saveField(‘has_regular’,1);
for($i=0;$i<=(count($_POST[‘title’])−1);$i++)
{

```
  $arr[‘title’] = $_POST[‘title’][$i];
  $arr[‘price’] = $_POST[‘price’][$i];
$this−>Extra−>create( );
$this−>Extra−>save($arr);
```

}

}

}

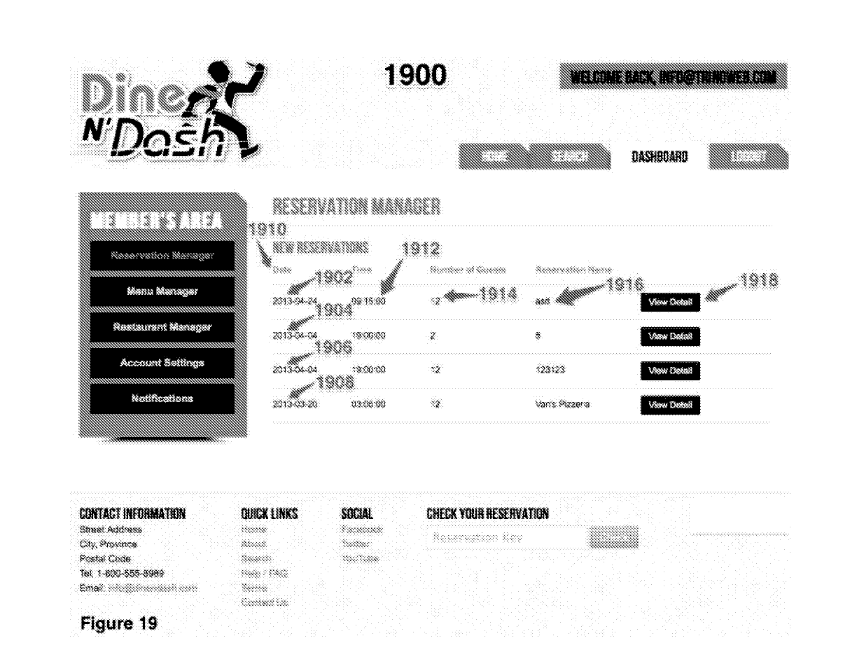

FIG. 19 is an example of a display screen of an online restaurant system of the present invention in which a restaurant may view all the reservations previously booked at the restaurant by various customers using the system of the present invention. The various reservations are shown at 1902, 1904, 1906, and 1908, and each shows the date 1910, time 1912, number of guests 1914, and reservation name 1916 of the reservation. In the embodiment displayed, further details can be accessed for each reservation through input button 1918.

Exemplary code for retrieving the reservation list corresponding to a particular restaurant follows. In this example, the “index” function of a reservations controller is called in order to get the reservation list of the logged in restaurant admin.

// To check if non admin is trying to browse the page and to restrict non-
admin

$this−>check_session( );
$res_id = $this−>Session−>read(‘res_id’);

// If a particular date is selected
if($date)

{

$arr = explode(‘_’,$date);
$this−>set(‘y’,$arr[0]); // getting the year value from the date
$this−>set(‘m’,$arr[1]); // getting the month value from the date

}

// if date is not selected, the date is set as today
if(!$date)

{

$dates = date(‘Y-m-d’);
$cond = array(‘res_id’=>$res_id,‘reservation_date LIKE

’=>$dates.“%”,‘parent_of’=>0,‘id IN (SELECT reser_id FROM
reskeys)’,‘cancelled <>’=>‘1’); /* Preparing the condition to get the
reservations in accordance to restaurant id, selected date and valid
reservation. The validity of reservation is supposed only if booking id/
Reservation key is created for that particular reservation */

}
else
{
// Preparing above condition for the user defined date

$cond =

array(‘res_id’=>$res_id,‘reservation_date’=>$date,‘parent_of’= >0, ‘id
IN
(SELECT reser_id FROM reskeys)’, ‘cancelled <>’=>‘1’);

}

// getting all the reservations using the above conditions and sending
them to reservation listing view in a paginated format

$this−>paginate =
array(‘conditions’=>$cond,‘order’=>‘reservation_date

DESC’, ‘limit’=>‘10’);

$this−>set(‘item’,$this−>paginate(‘Reservation’));

Exemplary sample code creating a table containing restaurant orders in database 112, and also showing the schema for such a table, is as follows:

CREATE TABLE IF NOT EXISTS ‘orders’ (

‘id’ int(11) NOT NULL AUTO_INCREMENT,
‘res_id’ int(11) NOT NULL,
‘menu_ids’ text NOT NULL,
‘ordered_on’ datetime NOT NULL,
‘ordered_till’ datetime NOT NULL,
‘ordered_by’ varchar(255) NOT NULL,
‘order_location’ varchar(255) NOT NULL,
‘phone_no’ varchar(255) NOT NULL,
‘email’ varchar(255) NOT NULL,
‘approved’ tinyint(4) NOT NULL DEFAULT ‘0’,
PRIMARY KEY (‘id’)

) ENGINE=InnoDB DEFAULT CHARSET=latin1
AUTO_INCREMENT=1 ;

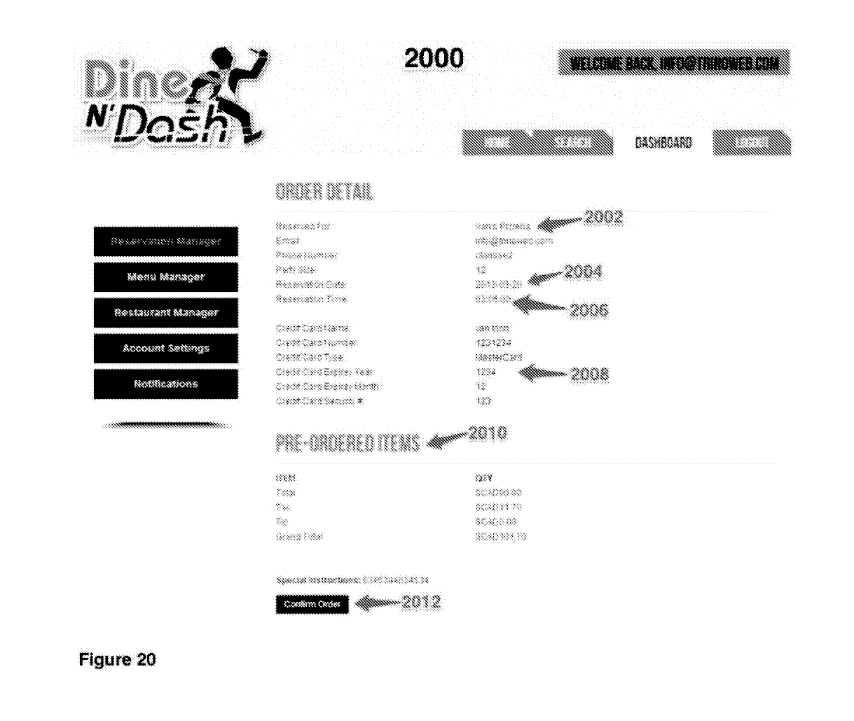

FIG. 20 is an example of a display screen of an online restaurant system of the present invention in which a particular reservation is being viewed in detail. Particulars of the customer making the reservation can be seen 2002, as well as reservation date 2004 and time 2006. Credit card information 2008 and menu items ordered (called “pre-ordered items” and listed as 2010) are also shown. Special instructions, if any are provided by the customer, may also appear in a further embodiment.

On this screen the restaurant user is provided with a confirmation button 2012 which allows the restaurant to confirm the reservation has been accepted at the restaurant to the customer. This button is not necessary if, for example, the online restaurant system of the invention provides the customer with a selection of available time slots and the restaurant chooses not to confirm reservations. In this case, the customer's selection is automatically accepted by the restaurant without the need to confirm.

Exemplary code that fetches the user and reservation information from the reservation table of database 112 follows.

$ord = $this−>Reservation−>find(
‘all’,array(‘conditions’=>array(‘OR’=>array(‘id’=>$id,‘parent_of’=>$id)),‘orde
r’=>‘parent_of, reservation_date ASC’));

It should be noted that, in this exemplary code, the parent reservation (i.e the reservation made by the original customer) and all other reservations made using the same booking id by the invited users are all merged. In this case, the additional menu items ordered by the subsequent customers given a unique identification code are stored in the database 112 as separate reservations, being linked by a booking ID field that links them to the parent reservation. However, other implementations are possible, one such other possible implementation of the present invention being to have the subsequent invited users add menu items and information to the original parent reservation itself, possibly associated with a “guest name” field so as to distinguish one guest from another.

Menus may be fetched using the following exemplary code:

$mf = $menu−>find(‘first’,array(‘conditions’=>array(‘id’=>$m)));echo
$mf[‘Menu’][‘menu_item’];

Referring to FIG. 20, when the customer confirms the reservation by clicking input button 2012, exemplary code which sets the reservation as approved, and to set all other reservations linked to the original parent reservation by booking IDs as also approved and not cancelled follows.

$this−>Reservation−>id = $id; // associating the reservation row with the
help of id

$this−>Reservation−>saveField(‘approved’,1); // saving the approved

field to 1 (which means approved)

$this−>Reservation−>saveField(‘ cancelled’ ,0); // saving the

cancelled field to 0 (which means cancelling the cancelled state if any)
// Find child reservations and set to approved and not cancelled:

$other = $this−>Reservation−

>find(‘all’,array(‘conditions’=>array(‘parent_of’=>$id)));

foreach($other as $o)
{

$this−>Reservation−>id = $o[‘Reservation’][‘id’];
$this−>Reservation−>saveField(‘approved’,1);
$this−>Reservation−>saveField(‘cancelled’,0);

}

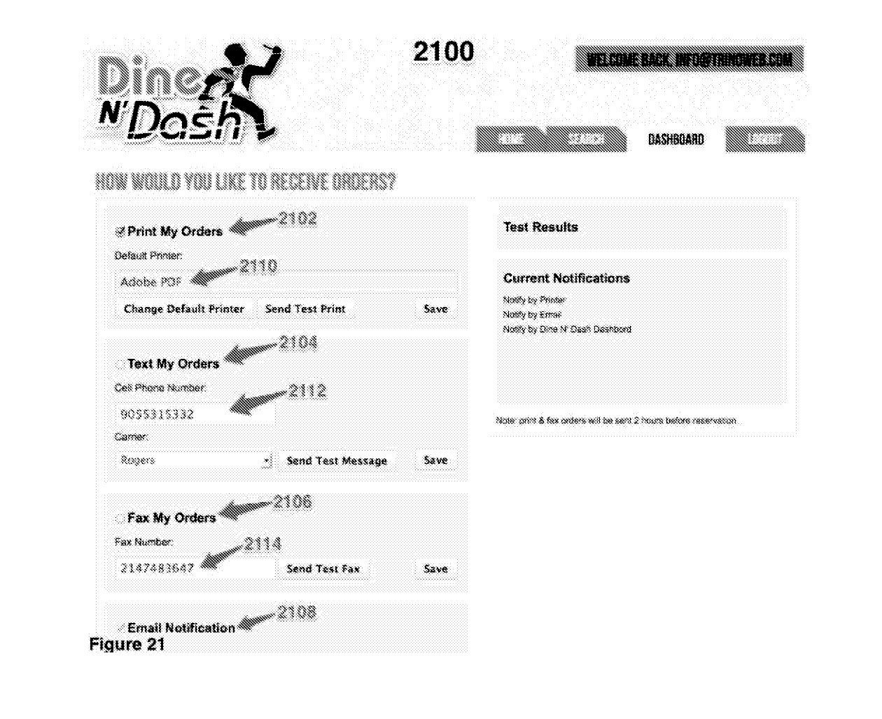

FIG. 21 is an example of a display screen of an online restaurant system of the present invention in which a restaurant may select how that restaurant wishes to receive notifications. As shown in FIG. 21, the restaurant may choose to receive notifications in a variety of means, including by printer 2102, SMS text to mobile device 2104, fax 2106 or email 2108. Various options are presented to the restaurant user under each of these selections that allows that user to particularize details about the notifications, for example such as where they are to be printed 2110; or the phone number of the mobile device 2112, or fax number 2114 to which the notifications will be sent.

The notifications that can be sent by the online restaurant system of the present invention may be a wide variety of notifications related to the functioning of the present system. For example, the restaurant may choose to be notified when a reservation is submitted, or when menu items are ordered, or to be alerted at the particular times when the restaurant needs to start preparing menu items so that they are ready to be served to the customer and any reservation guests by a particular time as selected by a customer, all as previously described.

As would be obvious to a person of skill in the art, the user interfaces shown in the Figures are merely exemplary, and can be of any format and style desired, and are not limited in the present invention, and the displays may be created and displayed by way of any technology suitable for creating displays and conveying information to and from users in computer systems.

Exemplary code to allow printing of these notifications, or sending them via SMS text message, or faxing them, follows:

// print

public function add($file = false) {

$id = ($this−>request−>data[‘user_id’]) ? $this−>request−

>data[‘user_id’] : AuthComponent::user(‘id’);

$title = $this−>request−>data[‘title’];
$resource = $this−>request−>data[‘resource’];
$printers = $this−>Printer−>getPrinters($id);
if (!empty($printers)) {

$printer_id =$this−>request−>data[‘printer_id’];
if ($printer_id == ‘_{——}google_{——}docs’)
{

$printer_id = $printers[‘printers’][‘1’][‘id’];

}
if ($file)
{

$response = $this−>Job−>addJobFromFile($resource,

$id, $printer_id, $title);

}
else
{

$response = $this−>Job−>addJobFromUrl($resource,

$id, $printer_id, $title);

}
if ($response && $response[‘success’] == ‘true’)
{

return true;

}
else
{

$job = array(

‘resource’ => $resource,
‘title’ => $title,
‘vendor_id’ => $id,
‘user_id’ => $id,
‘response’ => $response

);
throw new CakeException(‘Error with Print Job.

Details: ’ . json_encode($job)); # I like this better than serialize

}

}
else
{

throw new CakeException(‘User has no active printers’);

}

}

//Send SMS text message to notify restaurant
$emailphone = $_POST[‘phone’] . $_POST[‘carrier’];
$from = (array(‘info@x.ca’ => ‘Dine N Dash’));
$to = ($emailphone);
$sub = (‘SMS Test’);
$msg = (“This is a test from Dine N Dash”);
AppContnoller::Send_Email($from,$to,$sub,$msg);
unset($from,$to,$sub,$msg);
//fax user orders
$username = ‘x’; // Enter your Interfax username here
$password = ‘x’; // Enter your Interfax password here
$faxnumber = $_POST[‘fax’]; // Enter your designated fax number here
in the format +[country code][area code][fax number], for example:
+12125554874
$texttofax = ‘A new order was placed. Please log in to Dine N Dash for
more details.’; // Enter your fax contents here
$filetype = ‘TXT’; // If $texttofax is regular text, enter TXT here. If
$texttofax is HTML enter HTML here
/**************** Settings end ****************/
$client = new SoapClient(“http://ws.interfax.net/dfs.asmx?wsdl”);

| | |
|---|---|
| $params−>Username | = $username; |
| $params−>Password | = $password; |
| $params−>FaxNumber | = $faxnumber; |
| $params−>Data | = $texttofax; |
| $params−>FileType | = $filetype; |

$faxResult = $client−>SendCharFax($params);

Exemplary code for the MySQL table structure for a table called ‘tokens’ that handles authentication matters for, in this example, printers that access the Google API to provide printing services, follows:

CREATE TABLE IF NOT EXISTS ‘tokens’ (

‘id’ int(11) NOT NULL AUTO_INCREMENT,
‘user_id’ int(11) NOT NULL,
‘api’ varchar(255) NOT NULL,
‘access_token’ text NOT NULL,
‘modified’ datetime DEFAULT NULL,
‘refresh_token’ text,
‘token_secret’ text,
‘expires_in’ varchar(255) DEFAULT NULL,
PRIMARY KEY (‘id’),
UNIQUE KEY ‘user_id’ (‘user_id’, ‘api’)

) ENGINE=InnoDB DEFAULT CHARSET=utf8
AUTO_INCREMENT=7 ;

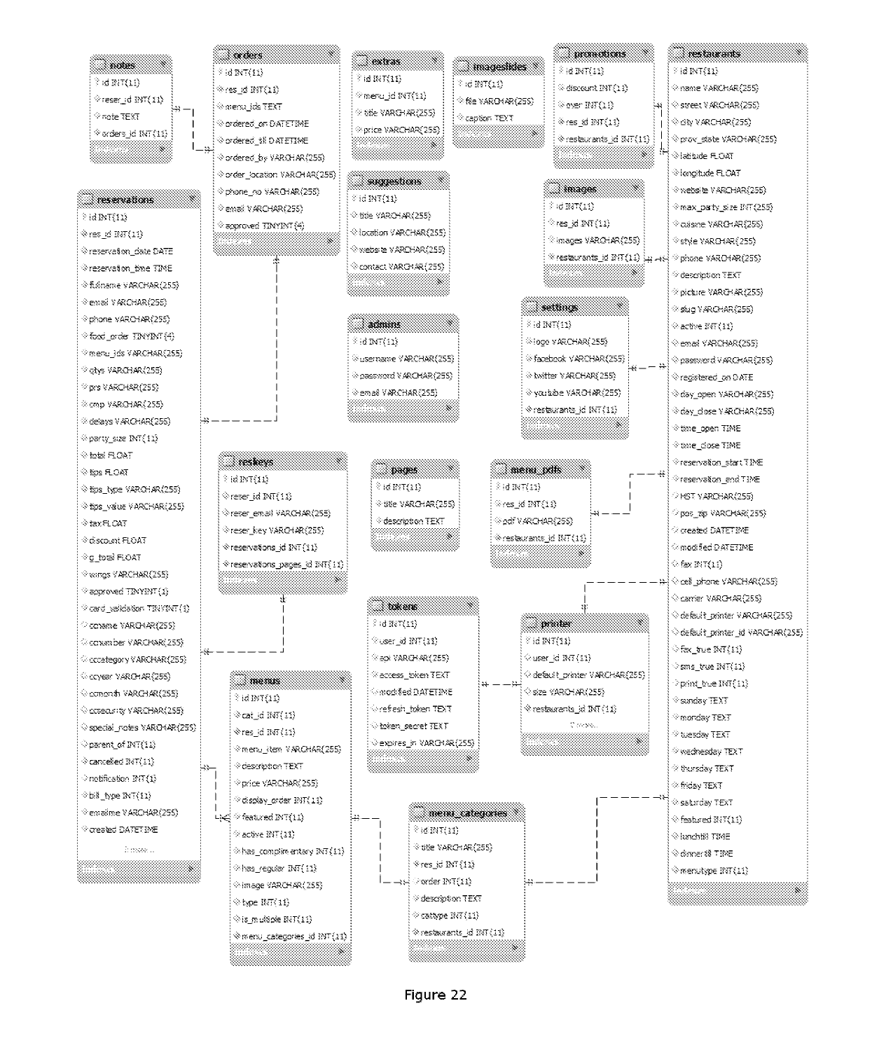

FIG. 22 is an overall schema diagram showing the interrelated tables of the database 112 of an embodiment of the present invention, showing the fields in each table, the field types, and the linkages (or lack thereof) between the various tables.

### Generalized Example

A generalized example of a particular embodiment of the invention is hereby provided to show how the invention works:

As shown in FIG. 5 and also FIG. 17, a restaurant user creates a profile in the computer system of the invention, accessing the system by any convenient means, including via the Internet by web browser 102 communicating with the system of the invention running as a web application 104 on a server, for example. Referring to FIG. 5, as shown in fields 502, the information entered by the restaurant user in the system might include, but is not limited to: restaurant name, location, days of the week that the restaurant is open for business, times that the restaurant accepts customer reservation bookings, and the menu items, price of same that can be ordered by customers. The information is stored in a database 112, or any other suitable information storing structure for where it may later be retrieved, such as flat computer files, to which the computer system of the invention is in communication.

In a particular embodiment of the invention, as stated previously, the information can be stored in any number of database systems, with a particularly exemplary database system being MySQL. The database tables required to accept the information required to give effect to the present invention would be variable depending on the information sought to be stored (by way of example only, whether pictures are to be stored next to each menu item, or whether ingredient notes including allergy information is stored next to each menu item, as two examples) but one particular exemplary schema for the various database tables in database 112 is as shown in FIG. 22. Alterations and modifications to such tables and to the arrangements to such tables would be trivial to those skilled in the art in order to store the relevant and required information.

In FIG. 22, the restaurant information is shown in table entitled “restaurants” and the fields stored in this embodiment, as examples, include fields to store the name of the restaurant, street, city, province or state, latitude and longitude (for possible use in Global Positioning System applications, such as communicating restaurants within a given distance to the user, or communicating a user's location and proximity to a restaurant, or displaying various restaurants on a map, and the like). Also included in this table are fields for website, maximum party size that the restaurant can accommodate, cuisine, style, phone number, description, pictures or images, short slugs for use in displaying public website pages relating to the restaurant, date the restaurant was registered, the days the restaurant is open and closed for business, the time the restaurant opens and closes for business, times for reservations, HST and tax information, contact information (including in the embodiment of FIG. 22 fax, cell phone and carrier information) and various other fields containing information about the various restaurants entered in the online system of the present invention. These fields contain information that would be entered by the restaurant user, or by an administrator entering this information on behalf of a restaurant user.

As shown in FIG. 6 and FIG. 18, and referring to FIG. 6, the restaurant user would be prompted to enter menu items 606 and prices 608 of those menu items, which information would be maintained in database 112 of the online reservation booking system of the present invention. Referring to FIG. 18, the restaurant may enter its menu items 1816 in categories 1810 to assist the customer with selecting them. Relating these items back to the embodiment of the present invention displayed in the schema in FIG. 22, the categories are found in the table entitled “menu_categories” and particular menu items are found in the table entitled “menus”.

In a preferred embodiment of the present invention, the restaurant user is prompted by the system to provide preparation times of each of the various menu items input into the system in relation to the particular restaurant. These preparation times are then used by the system in conjunction with the specific times at which the customers wished their food to be delivered, in order to time the preparation of the food for delivery to the customer at the desired time. Delivering the food at pre-set times minimizes the time the customer spends waiting for his or her food at the restaurant's table, causes the customer to finish his or her meal sooner, and thereby increases efficiency of table usage at the restaurant which in turn improves the restaurant's financial rate of return.

A sample calculation methodology of an embodiment of such a notification timing module would be as follows in Table 3 below.

TABLE 3
Sample calculation methodology of timing module

| step | action |
|---|---|
| 1 | retrieve the reservation time relating to a reservation order |
| 2 | retrieve the list of menu items ordered in relation to that reservation |
| 3 | for each menu item, retrieve its stored delay time |
| 4 | calculate time to send first notification time as: |
| | time1 = reservation time + delay for first menu item − |
| | preparation time (−optional further lead time) |
| 5 | issue notification to restaurant, reminding to start preparing |
| | first menu item, at time1 |
| 6 | calculate next menu item notification time as |
| | time2 = reservation time + delay for first menu item + delay for |
| | second menu item − preparation time (−optional further lead |
| | time) |
| 7 | repeat the issuing of notifications to restaurants for all menu items |
| | or as appropriate |

So an example in which a customer ordered a hamburger to be delivered 30 minutes after the start time of a reservation at 7 pm would be calculated as follows in Table 4.

TABLE 4
Calculation of menu item delivery time

| | resulting time |
|---|---|
| reservation start | 7 pm |
| +delay = 30 min. | 7.30 pm |
| −preparation time = 8 min. | 7.22 pm |
| −optional further lead time = 5 min. | 7.17 pm |

And the system in the above example of Table 4 would issue a notification to the restaurant at 7.17 pm to start preparing the hamburger for service to the customer by 7.30 pm.

Referring to FIG. 1, a customer 100 then accesses the system of the invention by any convenient or available means, including via the Internet, wherein the system of the invention would run as a web application 104. Alternately the computer system might also be accessed by a customer 100 locally if the system is made to run on, for example, a kiosk system where the customer accesses the system of the invention more or less directly and not across a remote network link. In another embodiment, the customer 100 might access the system locally via remote network through the use of a mobile device which is network-accessible and able to access the web application.

When a customer accesses the “home page” of the system of the invention, as exemplified in FIG. 2 or FIG. 10, he or she is shown a selection of restaurants who have created profiles in the computer system of the invention and that are stored in the database 112, a search mechanism, such as button 204, with which to search for restaurants according to various criteria, shown as 202 and 1002, which could include name, cuisine served, availability on a particular date, availability at a particular time, or other criteria with which to distinguish one restaurant from another. The customer might, instead or in addition to the search feature, also be provided with other information, such as a selection of restaurants recently dined at, a selection of restaurants near to the user's location, a selection of restaurants or any combination of these features or other similar features. An example of a further search page showing more detailed search parameters is shown in FIG. 11.

The online restaurant booking system of the invention can optionally allow the customer to allow the system to remember the customer, so that on future visits the computer system of the invention could display recently dined at restaurants, preferred cuisine, preferred dining times, or otherwise show the customer particular selections that might be of particular interest to him or her. The manner in which the computer system could remember a customer may include creating a user profile with login credentials, by name, or by technological means such as setting a cookie in the remote customer's web browser 102, keeping a record of the customer's mobile device serial numbers (IMEI numbers), or other tracking identifications where the customer uses their own device to access the restaurant system.

Referring to FIG. 10, the customer arriving at the home screen of the invention in this figure may be prompted to enter a unique identification code generated by the online restaurant system during a previous reservation booking Entering this unique identification code in 1010 allows the customer to access a pre-made reservation and change food orders, time of the reservation, number of guests, and other matters relating to the reservation. When given to a reservation guest, entering this code may, depending on the embodiment of the invention and the desire of the operator of the system, allow them also to edit the reservation or merely to view it.

In a preferred embodiment of the present invention, a method of distinguishing the customer making the original reservation and the subsequent reservation guests merely accessing the reservation may be desirable. In this case, one solution is to authenticate the customer, whether by having them enter personal information or by having them create a profile on the site, including user name and password. This latter is often cumbersome, with users not wanting to create a plethora of user names and passwords on many Internet or networked sites. Furthermore, the customer may not wish to provide personal information to be used as the authentication response.

A particular preferred embodiment solving these problems asks the customer to create a word to be used as authentication response. So, for example, the system might prompt the customer to select an animal, and upon a user entering the unique identification code, the system would then prompt the user to enter the animal selected. Failure to do so would indicate to the system that the person attempting to access the reservation was in fact a reservation guest and not the customer, and certain aspects of the reservation might then be made off-limits to this user (i.e. changing the time of the reservation). On the other hand, correct identification of the animal would indicate that the person was the customer, and full rights to edit the reservation would be granted.

Referring to the bottom portion of FIG. 2 and FIG. 11, the restaurant system returns search results for all restaurants meeting the customer's search criteria 202. In FIG. 2 is shown search results that also include open reservation slots for those restaurants, the customer may select one of the reservation times for one of these restaurants, in order to book that time, as shown at the bottom of FIG. 2. In this embodiment, the customer is asked to confirm the reservation, as shown in FIG. 3.

In another embodiment, exemplified by FIG. 11, no reservation times are shown, and the search results merely display the restaurant profiles themselves. Selecting one of these restaurants leads the customer to FIG. 12, the profile page for the restaurant itself, which shows menu items available at the restaurant. If deemed desirable by the customer, the customer may proceed to make a reservation as shown in FIG. 13, by entering the information required including date, time, party size, full name, email, and phone number. In this embodiment no reservation slots are selected. Instead, the customer merely chooses a desired time, and the restaurant must confirm back the reservation has been accepted.

Food Selection

As shown in FIG. 4 and FIG. 14, the customer may then be prompted to pre-order their food and select the food they wish to order from the restaurant. For each course, the customer will be asked to provide a time, or alternately a range of times, at which the customer wants that particular course served.

Referring to FIG. 15, once the food has been selected by the customer, the customer is shown the final order and asked to confirm it. Payment may be made at the restaurant, after the meal, as is typically done. Alternately, an embodiment of the invention involves the online restaurant billing system being used for pre-billing the customer at the point in time when they confirm the order. In this case, the customer would at that point be prompted by the online restaurant booking system of the invention, to provide payment information for the order. FIG. 15 shows the input fields required for credit card information to be collected from the customer. If the system has not already saved the customer's billing information from previous orders, the customer is then prompted to enter billing information. Alternate embodiments of the system may remember the customer's preferences in any number of manners known to persons of skill in the art, such as named logins, queries about personal information, unique user IDs, username and password combinations, cookies, device serial numbers, mobile device serial numbers (IMEI numbers), SIM card numbers, biometric data, or any other way known to persons of skill in the art to identify uniquely the customer on subsequent visits.

The computer system of the invention then, after the customer has completed and confirmed the initial reservation booking, assigns this reservation a unique identification code and provides this unique identification code back to the customer, as shown at the bottom of FIG. 15 at 1508. In one preferred embodiment of the present invention, this identification number may be used to allow the customer to log back in to the online restaurant reservation booking system at a later date in order to view, change or cancel their reservation, as shown in FIG. 10 at 1010.

This unique identification code can then however be provided to other third parties intending to attend the reservation, or reservation guests, and allows those reservation guests to access the reservation to view the reservation and, in a particularly preferred embodiment of the invention, to select their own menu items for consumption at the restaurant and the times they wish to have those menu items delivered to the table. In one further preferred embodiment of the invention, the reservations are locked within a certain period of time before the reservation is to start, to allow the restaurant to manage the reservations efficiently and effectively with no last minute changes to the orders placed.

Referring to FIG. 16, which is an example display page being viewed by a reservation guest who is viewing a pre-existing reservation, the menu items ordered by the customer and other reservation guests are shown at 1602. A receipt 1610 to the right of the order area shows the existing menu items ordered in the reservation, as well as tip, tax and grand total for the reservation as a whole. Inputs to skip food selection 1612 and to check-out 1614 are provided.

Where a reservation involves reservation guests, the customer making the initial booking may be asked to check-out and pay for the chosen menu items at the time that the customer makes the reservation and places his or her order. Alternately, the customer may be asked for a restaurant deposit towards the final cost of the reservation, with the full payment being made at the restaurant in person after the reservation has been completed.

In another embodiment, the customer does not check-out after they have made the reservation and selected their menu items. Instead, the online restaurant booking system notifies the customer when all the guests have viewed or added their desired menu items to the reservation, so that the customer may then re-access the computer system and the reservation made earlier, and then check-out and pay for all guests' chosen menu items.

In yet another embodiment, the customer is asked to check-out and pay for his or her menu items, and each reservation guest who accesses the system is asked by the system to check-out and pay for their own portion of the meal. Guests may be prompted to select their own meals after using the unique identification code to access the reservation through any number of methods all known in the art, but including allowing all guests to access all meals, or issuing a number of unique identification codes for use by the different guests, or by authenticating the guest by asking them to provide an e-mail address and associating that e-mail address to that particular guest for the purpose of allowing them to edit the reservation.

In a further alternate embodiment, an invoice is generated for the entire reservation once the customer and all the reservation guests have chosen their menu items, which invoice may then be delivered or sent to a third party to pay for the menu items purchased by the customer and reservation guests. This is especially suitable for workplace holiday parties or other special events where the employer pays for the purchases made by its employees.

Restaurants can manage the reservations made with them through other aspects of the back-end of this computer system previously discussed in FIG. 17 and FIG. 18. Referring to FIG. 19, for example, is a reservation manager screen which allows restaurants to view all reservations placed with that restaurant. The various reservations are shown at 1902, 1904, 1906, and 1908, and each shows the date 1910, time 1912, number of guests 1914, and reservation name 1916 of the reservation. Further details can be accessed for each reservation through input button 1918, which would take in this embodiment the restaurant user to a display screen such as in FIG. 20, showing the detail of the particular reservation selected.

Referring to FIG. 21, the computer system of the invention then notifies the restaurant of all reservation booking information, including the menu items ordered and times they are to be served, to the restaurant by any convenient or available means, including but not limited to by e-mail, fax, automated telephone system including automated telephone call, computer network, including both directly connected computers and by display on a website. Preferred is when the information is sent via the Internet to the restaurant. Especially preferred is when the computer system of the invention sends the information in machine-readable format to the restaurant's internal reservation system, and that system can process it directly, without human intervention. The restaurant's preferences as to notifications are accessible through a portion of the back-end of the restaurant system of the present invention, such as shown in FIG. 21, which allows the restaurant to select how they wish to receive notifications, and adjust preferences relating to the various notification methods.

A particularly preferred embodiment of the present invention includes, where the restaurant provides menu items and prices, having the restaurant enter the preparation time of the those items. In this preferred embodiment, once the restaurant receives the reservation booking including menu items, and when each menu item is to be delivered to the table. Knowing when the customer wants various courses served, and knowing how long it takes to create each menu item allows the restaurant to prepare the food so that it is ready to be served to the customer at the time the customer selected in the original reservation booking.

Various modifications and variations of the described systems and methods of the invention will be apparent to those skilled in the art without departing from the scope and spirit of the invention. Although the invention has been described in connection with specific preferred embodiments, it should be understood that the invention as claimed should not be unduly limited to such specific embodiments. Indeed, various modifications of the described modes for carrying out the invention which are obvious to those skilled in the art or related fields are extended to be within the scope of the following claims.

We claim:

1. A computer-implemented online restaurant reservation booking system for use by a customer to make a restaurant reservation booking at a restaurant, and for use by one or more reservation guests to modify said restaurant reservation booking, comprising:
a web application for receiving from the customer the restaurant reservation booking, the web application assigning the restaurant reservation booking a unique identification code, said unique identification code being usable by the one or more reservation guests to access the restaurant reservation booking via the web application in order to modify the restaurant reservation booking by:
(a) adding, removing, or substituting one or more menu items in the restaurant reservation booking, and/or
(b) changing a delivery time of the one or more menu items,
and wherein the web application provides the restaurant, via a communications means, with information concerning the restaurant reservation booking.

2. The computer-implemented online restaurant reservation booking system of claim 1 wherein the booking comprises a choice of any one or more of menu items, restaurant reservation time, time of delivery of at least one of the menu items, and the names of one or more reservation guests.

3. The online restaurant reservation booking system of claim 1, wherein the customer also selects one or more menu items.

4. The online restaurant reservation booking system of claim 1, wherein the unique identification code comprises information about the customer that uniquely identifies the customer.

5. The online restaurant reservation booking system of claim 4, wherein the unique identification code comprises a unique string of random characters or text selected by the customer.

6. The online restaurant reservation booking system of claim 1, wherein the communications means is any one or more of e-mail, fax transmission, by way of a printer, automated telephone call, display on a website, electronic message sent to a mobile device, electronic message sent to a mobile telephone, electronic message sent to a tablet, or electronic message sent to a PDA.

7. The online restaurant reservation booking system of claim 1 wherein the web application allows the customer to make electronic payment for the restaurant reservation booking by credit card, debit card or electronic wallet.

8. The online restaurant reservation booking system of claim 1 wherein the web application provides the customer with the unique identification code by any one of more of e-mail, fax transmission, by way of a printer, automated telephone call, display on a website, electronic message to a mobile device, electronic message to a mobile phone, electronic message to a tablet, or electronic message to a PDA.

9. The online restaurant reservation booking system of claim 1 wherein the web application notifies the customer when one or more of the reservation guests have accessed the restaurant reservation booking and selected the one or more menu items.

10. The online restaurant reservation booking system of claim 9, wherein the customer is notified by any one or more of e-mail, fax transmission, by way of a printer, automated telephone call, display on a website, electronic message to a mobile device, electronic message to a mobile phone, electronic message to a tablet, or electronic message to a PDA.

11. The online restaurant reservation booking system of claim 1, wherein the restaurant reservation booking also includes a desired time of arrival for the one or more menu items selected by the customer or by the one or more reservation guests.

12. The online restaurant reservation booking system of claim 11, wherein the restaurant reservation booking also includes a desired time by which the customer and the one or more reservation guests are to be finished at the restaurant.

13. The online restaurant reservation booking system of claim 1, wherein one or more restaurants may access the web application and add, delete, and update menu items made available for selection by the customer and the one or more reservation guests, and prices of the menu items.

14. A method for providing an improved restaurant reservation booking through an online restaurant reservation booking system, comprising:
providing an online booking system for a customer to make a restaurant reservation booking,
allowing the customer to select one or more menu items offered by the restaurant, the one or more menu items being included in the restaurant reservation booking,
assigning the restaurant reservation booking a unique identification code,
providing at least the customer and optionally the at least one or more reservation guests with the unique identification code,
said unique identification code allowing the one or more reservation guests to access the restaurant reservation booking via the web application in order to modify the restaurant reservation booking by;
(a) adding, removing, or substituting one or more menu items in the restaurant reservation booking, and/or
(b) changing a delivery time of the one or more menu items.

15. A method according to claim 14 further comprising the step of notifying the customer once one or more reservation guests have accessed the restaurant reservation booking.

16. A method according to claim 14 further comprising the step of collecting payment from the customer for at least a portion of the cost of the restaurant reservation booking.

17. A method according to claim 14 further comprising the step of collecting payment from at least one of the one or more reservation guests for at least a portion of the cost of the restaurant reservation booking.

18. A method according to claim 14 wherein the unique identification code is provided to the customer by any one or more of e-mail, fax transmission, by way of a printer, automated telephone call, display on a website, electronic message to a mobile device, electronic message to a mobile phone, electronic message to a tablet, or electronic message to a PDA.

19. A method according to claim 14 further comprising the steps of:
collecting contact information for the one or more reservation guests, and sending the unique identification code directly to the one or more reservation guests by e-mail, fax transmission, by way of a printer, automated telephone call, display on a website, electronic message to a mobile device, electronic message to a mobile phone, electronic message to a tablet, or electronic message to a PDA.
